(19) United States
(12) Patent Application Publication
(10) Pub. No.: US 2004/0255113 A1
(43) Pub. Date: Dec. 16, 2004

(54) Digital certificate management system, apparatus and software program

(76) Inventor: Masaaki Ogura, Kawasaki-shi (JP)

Correspondence Address: KNOBLE YOSHIDA & DUNLEAVY LLC, Suite 1350, Eight Penn Center, 1628 John F. Kennedy Blvd., Philadelphia, PA, 19103, US

(21) Appl. No.: 10/815,043

(22) Filed: Mar. 31, 2004

(30) Foreign Application Priority Data
Mar. 31, 2003 (JP) 2003-096240

(51) Int. Cl. G06F 11/30

(52) U.S. Cl. 713/156; 713/201

(57) ABSTRACT

The communication devices are produced with a distinct digital certificate to later identify themselves during communication with a central management apparatus. The identity of the communication device guarantees that appropriate information is provided to the central management apparatus from the communication device. For example, if charge information is uploaded from the communication terminal to the central management apparatus to generate an invoice or a charge, the information should be native or germane to the original device containing the communication device. To avoid the inaccurate information, the digital certificate is confirmed against a predetermined list of the digital certificates at the central management apparatus prior to uploading the information.

### FIELD OF THE INVENTION

The current invention is generally related to an information management system or software program, and more particularly related to the system including an information processing device for transmitting predetermined information to a communication device and writing it to memory of the communication device and a digital certificate management device for communicating with the information processing device via a network. The current invention is also particularly related to the computer program for practicing a method of obtaining a digital certificate at the above information processing device.

### BACKGROUND OF THE INVENTION

A remote management system was proposed in the past that a remote management device at a service center remotely controls managed devices via networks such as the Internet and public lines. The managed devices include electronic devices with measuring units and communication units. The measuring units are applicable for the water, electricity and gas consumption and also applicable to air conditioning units, electrical power supply units, medical devices, automatic vending machines, the network-based consumer electronics as well as the image processing devices. Certain image processing devices includes multi-functional digital devices, scanners, digital copies, facsimiles (fax) and printers with communication capability.

On the other hand, if the managed devices do not have communication capability or the managed devices have only limited communication capability without a function to communicate with a central or remote management system, it has been proposed that an intermediate device with the communication function is connected via network and that the remote management system manages the managed devices via the network and the intermediate device.

Meanwhile, a client server system has been put together by connecting via network a plurality of computers such as personal computers at least one of which is designated as a server device and at least another one of which is designated as a client. In the above client-server system, a request is transmitted from the client to the server. In response to the request from the client, the server performs a corresponding process and transmits a response back to the client.

In the above described remote management system, the communication device or the intermediate device connected to the communication device have the client device functions while the central management device has the server device functions. When the communication device or the intermediate device is connected to the central management device via firewalls and network, the communication device or the intermediate device reports the polling results on the transmission request to the central management device. The central management device performs a handling process according to the polling results and returns a response to the communication device or the intermediate device. For example, the central management device reports to the intermediate device a charge counter obtaining request in response to the polling result from the intermediate device. Upon receiving the charge counter obtaining request from the central management device, the polling-destination intermediate device reports the charge counter obtaining request to an image forming device that is connected to the intermediate device itself. In response to the charge counter obtaining request from the intermediate device, the image forming device reads the data stored in the non-volatile memory and transmits the read data or the response data for the charge counter to the intermediate device. The intermediate device in turn transmits the charge counter data to the central management device.

In the above described situation, it is important to confirm whether the information to be transmitted is updated or whether the communication destination is proper. Furthermore, since the information is passed on the Internet frequently among computers that are not relevant before it reaches the communication destination, it is necessary to protect the secret data such as the charge counter data during the transmission. For example, one communication protocol for the above requirements is called Secure Socket Layer (SSL) that has been developed and widely used. Based upon the above protocol, by combining a public key coding method and a common key coding method, a communication partner is confirmed, and the manipulation or misappropriation of the coded data is prevented.

Referring to FIG. 24, a flow chart illustrates a communication sequence for mutually recognizing a client device and a server device based upon the SSL. The sequence will be described in detail with respect to the confirmation. The client device includes a communication device or an intermediate device while the server device includes an intermediate device. To mutually recognize based upon the SSL, it is necessary to store a route key certificate, a client private key and a client public key certificate or a client certificate at the client device. The client private key is a private key that a certificate authority (CA) has issued to a particular one of the client devices. The client public key certificate is a digital certificate that the CA has added a digital signature to the public key that corresponds to its private key. The route key certificate is a digital certificate that the CA has added a digital signature to a route key or a certificate public key (certificate key) that corresponds to the route private key which the CA uses for digital signature. It is necessary to store the route key certificate, the server private key and the server public key certificate in the server device. The server private key and server public key certificate are the corresponding ones that the CA has issued the server device. It is assumed that the same CA has issued the client device and the server device the certificate based upon the same route private key. In this case, the route key certificate is common between the client device and the server device.

Still referring to FIG. 24, steps S11 through S27 describe the process at the client and parent devices. The arrows between the client and server processes indicate data transfers. A transmission side performs the transmission at the step that is located at the origin of the arrow while a reception side performs a step located at the tip of the arrow upon receiving the data information. When each step is not normally completed, the process is interrupted by returning a confirmation failure response. Upon receiving the confirmation failure response from the destination, the process is treated the same as if a time out has occurred. In the client-server system, the client device requests a connection. When the connection request is necessitated by a user instruction, the client device CPU initiates by executing a necessary control program a process in the left side of the flow chart in FIG. 24. On the other hand, upon receiving the connection request, the server device CPU initiates by executing a necessary control program a process in the right side of the flow chart in FIG. 24.

In the step S11, a connection request is transmitted from the client device to the server device. The server process at the step S21 receives the request and generates a random number. The step S21 further codes the generated random number based upon a predetermined server private key. In the step S22, the server process transmits the coded first random number and the server public key certificate to the client process. In the step S22, the server device CPU functions as a first server confirmation processing means. In the step S12, upon receiving the transmission, the client process confirms the authenticity of the server public key certificate based upon a route certificate. In the authentication process, not only it is confirmed that the certificate has experienced damage or alteration, but also it is confirmed that the server device is a proper communication device based upon the reference information. Following the confirmation, the client process in the step S13 decodes the coded first random number by the server public key contained in the server public key certificate. After a successful decoding step, it is confirmed that the first random number is indeed received from the server device that has been issued the server public key certificate. Thus, the server device is confirmed as a proper communication destination. In the above steps S12 and S13, the client device CPU functions as a second client confirmation processing means.

The client process in the step S14 now generates a second and third random numbers. The client process in the step S15 then codes the second random number based upon the client private key and the third random number based upon the server public key. The client process in the step S16 transmits the above coded second and third numbers with the client public key certificate to the server process. The third random number coding is performed to avoid the random number value to be known to devices other than the server device. In the above step S16, the client device CPU functions as a first client confirmation processing means. Upon receiving the transmitted data, the server process in the step S23 confirms the authenticity of the client public key certificate based upon the route key certificate. As similarly in the step S12, the step S23 includes a confirmation that the client device is a proper communication partner. After the confirmation, the server process in the steps S24 and S25 now decodes the second and third coded random numbers respectively based upon the client public key and the server private key. In the above steps S23 and S24, the server device CPU functions as a second confirmation processing means. At least, the third random number is not know to other devices except for the client device that has generated it and the server device having the server private key. Upon successful decoding, the server process returns a success response to the client process in the step S26. Upon receiving the response at the client device, the client process generates a common key based upon the first, second and third random numbers in the step S17 and subsequently uses the common key for coding. The client process then terminates. The server process generates a common key based upon the first, second and third random numbers in the step S27 and subsequently uses the common key for coding. The server process then terminates. The server and client devices utilizes the common key that is generated in the step S17 or S27 in order to communicate with each other by coding the data according to the common key coding method. Consequently, the server and client devices safely exchange the common key after confirming each other in order to communicate with the confirmed partner.

Now referring to FIG. 25A, a diagram illustrates components of the client public key. The client public key includes a key body for decoding documents that have been coded by a client private key as well as reference information on the issuing CA for the public key, the client device that has been issued the public key and the expiration date. The CA adds the client public key a digital signature that is a coded hash value from the client public key based upon a route private key. The identification information of the route private key to be used for the digital signature is added to the reference information of the public key. The public key certificate with the digital signature is the client public key certificate. When the client public key certificate is used for confirmation, the digital signature is decoded using the key body of the route key that corresponds to the route private key. If the decoding process is performed successfully, it is confirmed that the digital signature is added by the CA. Furthermore, if the hash value obtained from the client public key portion matches the hash value from the decoding process, it is also confirmed that the key itself is free from damage or alteration. If the received data is successfully decoded based upon the client public key, it is confirmed that the data has been transmitted from the client device who owns the client private key. Subsequently, it is determined whether or not confirmation is finalized by referring to the reference information such as the CA credibility and the registration of the client device.

Now referring to FIG. 25B, a diagram illustrates components of the route key. It is necessary in advance to store the route key in the route key certificate in which the CA has added a digital signature. The route key certificate is a self-signed format by decoding the digital signature with the public key contained in itself. When the route key is used, the digital signature is decoded by the key body that is contained in the route key certificate. The hash value is obtained by hashing the route key and is then compared. If the hash value matches, it is confirmed that the route key is free from damage or alteration.

In the above described remote management system, in order for a communication device to communicate with the central management device through the SSL for the mutual recognition, it is also necessary in advance to store in the internal memory the digital certificates that include the route key certificate, the client private certificate and the client public key certificate. The digital certificate is obtained from the CA. For example, the Japanese Patent Publication 2001-325249 discloses one way of obtaining the digital certificates. It is necessary to have a license agreement with a sales company of the communication devices, and the remote management device becomes possible by the license.

The communication device to be used in the remote management system is produced by a predetermined daily number for each device model. It is determined whether or not the digital certificate is stored in the internal memory of each device model. That is, it is determined whether or not the communication device responds to the remote management by the central remote management device. Since the communication devices are not produced based upon a certain order, it is not possible that the communication devices are produced with the internal memory storing the digital certificates after a conservative license agreement is made. For this reason, even if a license agreement has not been made, since the communication devices with an internal memory unit storing the digital certificate exist, the communication devices are later remotely managed by the management device as if they are under the license agreement. For example, a device user owns two communication devices. If a first communication device without an agreement has a smaller value in the charge account than a second communication device with an agreement, it is possible to use the first communication device as the second communication device to transmit the smaller charge counter value to the central management device so that the charge is in effect reduced. At the central management, since the charge is made to the device user based upon the charge counter value received from the first communication device, the smaller charge amount is charged to the above device user. Thus, it remains desirable for the central management device to accurately determine whether the communication device is under the agreement when the communication device confirms with the central management device.

### SUMMARY OF THE INVENTION

In order to solve the above and other problems, according to a first aspect of the current invention, a method of obtaining a digital certificate for communication devices, including the steps of: storing digital certificates each with corresponding identification information in a digital certificate management device; adding identification information of a communication device to a digital certificate transmission request for obtaining a digital certificate to be used for confirming the communication device during communication; transmitting the identification-information-added digital certificate transmission request to the digital certificate management device; receiving a corresponding one of the digital certificates from the digital certificate management device in response to the identification-information-added digital certificate transmission request; transmitting the correspondingly received digital certificate to the communication device; and writing the correspondingly received digital certificate to memory in the communication device.

According to a second aspect of the current invention, a method of obtaining a digital certificate for communication devices, including the steps of: storing digital certificates each with corresponding identification information in a digital certificate management device; adding identification information of a predetermined number of communication devices for production to a digital certificate transmission request for obtaining digital certificates to be used for confirming the communication devices during communication; transmitting the identification-information-added digital certificate transmission request to the digital certificate management device; receiving corresponding ones of the digital certificates from the digital certificate management device in response to the identification-information-added digital certificate transmission request; temporarily storing the correspondingly received digital certificates in memory of an information processing device; inputting a portion of the identification information on the predetermined number of the communication devices; reading the digital certificates corresponding to the inputted identification information from the information processing device; transmitting each of the correspondingly read digital certificates to a corresponding one of the communication devices according to the inputted identification information; and writing each of the correspondingly read digital certificates to memory in the corresponding one of the communication devices.

According to a third aspect of the current invention, a method of obtaining a digital certificate for communication devices, including the steps of: storing digital certificates each with corresponding identification information in a digital certificate management device; adding identification information of a predetermined number of communication devices for production to a digital certificate transmission request for obtaining digital certificates to be used for confirming the communication devices during communication; transmitting the identification-information-added digital certificate transmission request to the digital certificate management device; receiving corresponding ones of the digital certificates from the digital certificate management device in response to the identification-information-added digital certificate transmission request; temporarily storing the correspondingly received digital certificates in memory of an information processing device; scanning a barcode indicative of the identification information on the predetermined number of the communication devices from a predetermined source; reading the digital certificates corresponding to the scanned identification information from the information processing device; transmitting each of the correspondingly read digital certificates to a corresponding one of the communication devices according to the scanned identification information; and writing each of the correspondingly read digital certificates to memory in the corresponding one of the communication devices.

According to a fourth aspect of the current invention, an information processing apparatus for obtaining a digital certificate for communication devices, including: a digital certificate transmission request unit for adding identification information of a communication device to a digital certificate transmission request for obtaining a digital certificate to be used for confirming the communication device during communication and transmitting the identification-information-added digital certificate transmission request to a digital certificate management device; and a digital certificate processing unit connected to the digital certificate transmission request unit for receiving a corresponding one of the digital certificates from the digital certificate management device in response to the identification-information-added digital certificate transmission request, the processing digital certificate unit transmitting the correspondingly received digital certificate to the communication device and writing the correspondingly received digital certificate to memory in the communication device.

According to a fifth aspect of the current invention, an information processing apparatus for obtaining a digital certificate for communication devices, including: a digital certificate transmission request unit for adding identification information of a predetermined number of communication devices for production to a digital certificate transmission request for obtaining digital certificates to be used for confirming the communication devices during communication, the digital certificate transmission request unit transmitting the identification-information-added digital certificate transmission request to a digital certificate management device; a digital certificate processing unit connected to the digital certificate transmission request unit for receiving corresponding ones of the digital certificates from the digital certificate management device in response to the identification-information-added digital certificate transmission request, the digital certificate processing unit temporarily storing the correspondingly received digital certificates in memory of an information processing device; and an inputting unit connected to the digital certificate processing unit for inputting a portion of the identification information on the predetermined number of the communication devices to the digital certificate processing unit, wherein the digital certificate processing unit reading the digital certificates corresponding to the inputted identification information from the information processing device, the digital certificate processing unit transmitting each of the correspondingly read digital certificates to a corresponding one of the communication devices according to the inputted identification information and writing each of the correspondingly read digital certificates to memory in the corresponding one of the communication devices.

According to a sixth aspect of the current invention, an information processing apparatus for obtaining a digital certificate for communication devices, including: a digital certificate transmission request unit for adding identification information of a predetermined number of communication devices for production to a digital certificate transmission request for obtaining digital certificates to be used for confirming the communication devices during communication, the digital certificate transmission request unit transmitting the identification-information-added digital certificate transmission request to a digital certificate management device; a digital certificate processing unit connected to the digital certificate transmission request unit for receiving corresponding ones of the digital certificates from the digital certificate management device in response to the identification-information-added digital certificate transmission request, the digital certificate processing unit temporarily storing the correspondingly received digital certificates in memory of an information processing device; and a scanning unit connected to the digital certificate processing unit for scanning a barcode indicative of the identification information on the predetermined number of the communication devices from a predetermined source, wherein the digital certificate processing unit reading the digital certificates corresponding to the scanned identification information from the information processing device, the digital certificate processing unit transmitting each of the correspondingly read digital certificates to a corresponding one of the communication devices according to the scanned identification information and writing each of the correspondingly read digital certificates to memory in the corresponding one of the communication devices.

According to a seventh aspect of the current invention, an information management system over a network, including: a communication device further including a memory unit for storing a digital certificate; an information processing unit connected to the communication device further including: a digital certificate transmission request unit for adding identification information of a predetermined number of the communication devices for production to a digital certificate transmission request for obtaining digital certificates to be used for confirming the communication devices during communication and for transmitting the identification-information-added digital certificate transmission; and a first digital certificate transmission unit connected to the digital certificate transmission request unit; and a digital certificate management unit connected to the information processing unit further including: a digital certificate generation unit for receiving the identification-information-added digital certificate transmission and generating a corresponding one of the digital certificates; and a second digital certificate transmission unit connected to the digital certificate generation unit for transmitting the corresponding one of the digital certificates to the information processing unit, wherein the digital certificate transmission unit receiving the corresponding one of the digital certificates from the second digital certificate transmission unit in response to the identification-information-added digital certificate transmission request, the first digital certificate transmission unit transmitting the correspondingly received digital certificate to the communication device and writing the correspondingly received digital certificate to the memory in the communication device.

According to an eighth aspect of the current invention, an information management system over a network, including: a communication device further including a memory unit for storing a digital certificate; an information processing unit connected to the communication device further including: an input unit for inputting identification information for the communication device; a digital certificate transmission request unit for adding identification information of a predetermined number of the communication devices for production to a digital certificate transmission request for obtaining digital certificates to be used for confirming the communication devices during communication and for transmitting the identification-information-added digital certificate transmission; a digital certificate storage unit for storing the digital certificates; and a first digital certificate transmission unit; and a digital certificate management unit connected to the information processing unit further including: a digital certificate generation unit for receiving the identification-information-added digital certificate transmission and generating a corresponding one of the digital certificates; and a second digital certificate transmission unit connected to the digital certificate generation unit for transmitting the corresponding one of the digital certificates to the information processing unit, wherein the digital certificate storage unit receiving the corresponding one of the digital certificates from the second digital certificate transmission unit in response to the identification-information-added digital certificate transmission request, the first digital certificate transmission unit reading the correspondingly received digital certificate from the digital certificate storage unit based upon the inputted identification information and transmitting the correspondingly read digital certificate to the communication device so as to write the correspondingly read digital certificate to the memory in the communication devices

According to a ninth aspect of the current invention, an information management system over a network, including: a communication device further including a memory unit for storing a digital certificate; an information processing unit connected to the communication device further including: a scanning unit for scanning a barcode from the communication device as identification information for the communication device; a digital certificate transmission request unit for adding identification information of a predetermined number of the communication devices for production to a digital certificate transmission request for obtaining digital certificates to be used for confirming the communication devices during communication and for transmitting the identification-information-added digital certificate transmission; a digital certificate storage unit for storing the digital certificates; and a first digital certificate transmission unit; and a digital certificate management unit connected to the information processing unit further including: a digital certificate generation unit for receiving the identification-information-added digital certificate transmission and generating a corresponding one of the digital certificates; and a second digital certificate transmission unit connected to the digital certificate generation unit for transmitting the corresponding one of the digital certificates to the information processing unit, wherein the digital certificate storage unit receiving the corresponding one of the digital certificates from the second digital certificate transmission unit in response to the identification-information-added digital certificate transmission request, the first digital certificate transmission unit reading the correspondingly received digital certificate from the digital certificate storage unit based upon the scanned identification information and transmitting the correspondingly read digital certificate to the communication device so as to write the correspondingly read digital certificate to the memory in the communication device.

According to a tenth aspect of the current invention, a computer program performing certain functions for ultimately writing a digital certificate in a memory unit in communication devices, the functions including: storing digital certificates each with corresponding identification information in a digital certificate management device; transmitting an identification-information-added digital certificate transmission request to the digital certificate management device after adding identification information of a communication device to the identification-information-added digital certificate transmission request for obtaining a digital certificate to be used for confirming the communication device during communication; and transmitting a correspondingly received digital certificate to the communication device and writing the correspondingly received digital certificate to memory in the communication device after receiving the corresponding one of the digital certificates from the digital certificate management device in response to the identification-information-added digital certificate transmission request.

According to an eleventh aspect of the current invention, a computer program performing certain functions for ultimately writing a digital certificate in a memory unit in communication devices, the functions including: storing digital certificates each with corresponding identification information in a digital certificate management device; transmitting an identification-information-added digital certificate transmission request to the digital certificate management device after adding identification information of a predetermined number of communication devices for production to the identification-information-added digital certificate transmission request for obtaining digital certificates to be used for confirming the communication devices during communication; temporarily storing correspondingly received digital certificates in memory of an information processing device after receiving the corresponding ones of the digital certificates from the digital certificate management device in response to the identification-information-added digital certificate transmission request; and transmitting each of corresponding digital certificates to a corresponding one of the communication devices according to inputted identification information and writing each of the corresponding digital certificates to memory in the corresponding one of the communication devices after reading the digital certificates corresponding to a portion of the inputted identification information on the predetermined number of the communication devices.

According to a twelfth aspect of the current invention, a computer program performing certain functions for ultimately writing a digital certificate in a memory unit in communication devices, the functions including: storing digital certificates each with corresponding identification information in a digital certificate management device; transmitting an identification-information-added digital certificate transmission request to the digital certificate management device after adding identification information of a predetermined number of communication devices for production to the identification-information-added digital certificate transmission request for obtaining digital certificates to be used for confirming the communication devices during communication; temporarily storing correspondingly received digital certificates in memory of an information processing device after receiving the corresponding ones of the digital certificates from the digital certificate management device in response to the identification-information-added digital certificate transmission request; and transmitting each of corresponding digital certificates to a corresponding one of the communication devices according to scanned a barcode indicative of identification information and writing each of the corresponding digital certificates to memory in the corresponding one of the communication devices after reading the digital certificates corresponding to a portion of the scanned identification information on the predetermined number of the communication devices.

According to a thirteenth aspect of the current invention, a communication device production system in connection with digital certificate management, including: a production management system for managing production of a predetermined set of communication devices; a digital certificate database for storing digital certificates; a communication terminal connected to the production management system, the digital certificate database and the digital certificate management for controlling a flow of obtaining the digital certificates from the digital certificate management and delivering the digital certificates to the communication devices based upon a digital certificate request; and a factory terminal connected to the communication terminal and the communication devices for delivering the digital certificates to the communication devices as specified by the digital certificate request.

According to a fourteenth aspect of the current invention, a method of producing communication devices with digital certificates, including the steps of: managing production lines for a predetermined set of communication devices; storing digital certificates in a digital certificate database; and controlling a flow of obtaining the digital certificates from the digital certificate management and delivering the digital certificates to the communication devices based upon a digital certificate request.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a conceptual diagram illustrating an example of the construction of the remote management system according to the current invention.

FIGS. 2A and 2B are conceptual diagrams illustrating data transmission and reception models of the above-mentioned transmission and reception.

FIG. 3 is a conceptual diagram illustrating a preferred embodiment of the image forming apparatus management system according to the current invention.

FIG. 4 is a block diagram illustrating a preferred embodiment of the physical construction of the image forming apparatus 100 according to the current invention.

FIG. 5 is a table illustrating an exemplary content of the flash memory unit 204 to be used with the current application.

FIG. 6 is a table illustrating an exemplary content of the non-volatile random access memory (NVRAM) unit 207 to be used with the current application.

FIG. 7 is a block diagram illustrating an example of the software configuration of the image forming apparatus 100 according to the current invention.

FIG. 8 is a functional block diagram illustrating one preferred embodiment of the modules of the NRS 305 according to the current invention.

FIG. 9 is a block diagram illustrating an example of the components of the central management apparatus 102 according to the current invention.

FIG. 10 is a block diagram illustrating components of the factory E in a preferred embodiment according to the current invention.

FIG. 11 is a block diagram illustrating components of the certificate management device 607 in the preferred embodiment according to the current invention.

FIG. 12 is a block diagram illustrating hardware components of the communication terminal 150 in the preferred embodiment according to the current invention.

FIG. 13 is a block diagram illustrating hardware components of the factory terminal 160 in the preferred embodiment according to the current invention.

FIG. 14 is a block diagram illustrating peripheral devices around the communication terminal 150 and the factory terminal 160 at the production factory E according to the current invention.

FIG. 15 is a diagram illustrating the exemplary connections among the factory terminal 160, the barcode reader 141 and the communication device according to the current invention.

FIG. 16 is a diagram illustrating one exemplary rated inscription plate attached to the image forming device 100 or 110 according to the current invention.

FIG. 17 is a diagram illustrating exemplary production steps of producing the communication device at the first, second and third production lines 1001, 1002 and 1003 at the production factory E of FIG. 14.

FIG. 18 illustrates an exemplary pseudo timing chart or sequence for obtaining certificates for the image forming device management system according to the current invention.

FIG. 19A is a table illustrating the exemplary database content for the certificate management device list.

FIG. 19B is a table illustrating the exemplary database content for the production plan.

FIG. 20 is a table illustrating exemplary contents of the certificate database 154a in the HDD 154 of the communication terminal 150 according to the current invention.

FIG. 21 illustrates exemplary contents and the data formats to be used for communicating with the communication terminal 150 according to the current invention.

FIG. 22 illustrates exemplary contents and the data formats to be used for communicating between the communication terminal 150 and the factory terminal 160 according to the current invention.

FIGS. 23A and 23B illustrate exemplary contents and the data formats to be used for communicating between the communication device such as the image forming apparatus 100 and the factory terminal 160 according to the current invention.

FIG. 24 is a flow chart illustrating a communication sequence for mutually recognizing a client device and a server device based upon the SSL.

FIG. 25A is a diagram illustrating components of the client public key.

FIG. 25B is a diagram illustrating components of the route key.

### DETAILED DESCRIPTION OF THE PREFERRED EMBODIMENT(S)

Based upon incorporation by external reference, the current application incorporates all disclosures in the corresponding foreign priority document JPAP2003-096240 from which the current application claims priority.

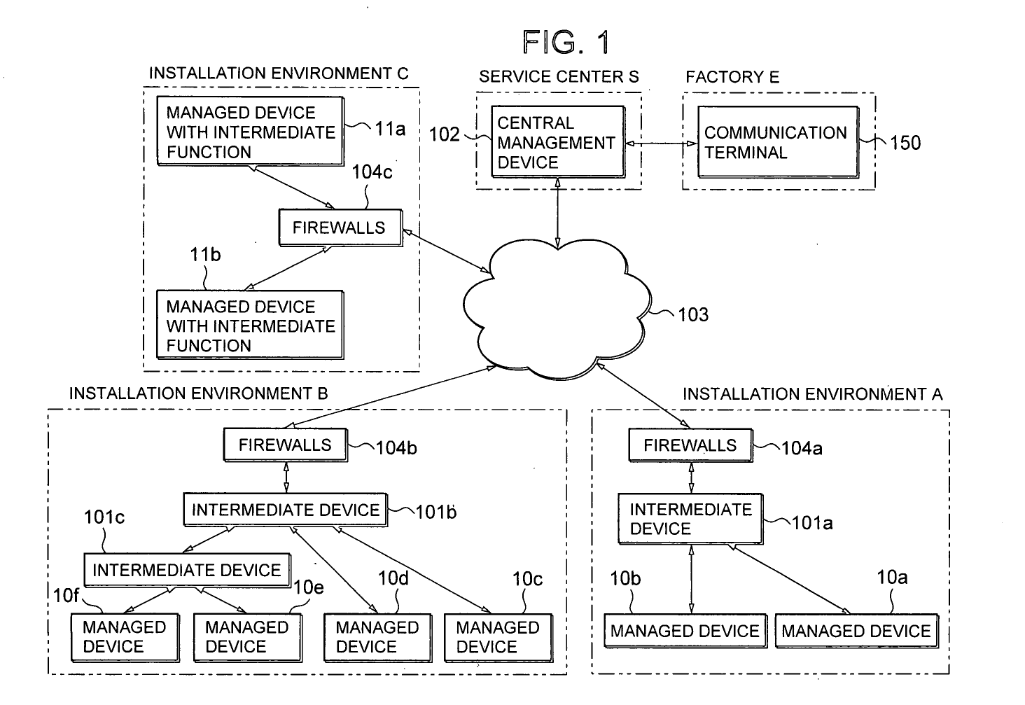

Referring now to the drawings, wherein like reference numerals designate corresponding structures throughout the views, and referring in particular to FIG. 1, a conceptual diagram illustrates an example of the construction of the remote management system. The remote management system manages managed apparatuses 10 (10a, 10b, 10c, 10d, 10e, and 10f), which are image forming apparatuses such as a printer, a FAX apparatus, a digital copying apparatus, a scanner and a digital multi-functional apparatus, and communication apparatuses or electronic apparatuses such as network-based home appliances, automatic vending machines, medical equipment, power supply equipment, air conditioning systems and measuring systems of gas, water, electricity. The remote management system includes intermediate apparatuses 101 (101a, 101b, and 101c) that serve as remote management intermediate apparatuses which are connected with the managed apparatuses 10 via a local area network (LAN) external apparatuses. The managed apparatuses 10 are connected when they are seen from the managed apparatuses 10. Further, the remote management system includes a management apparatus 102 that functions as a server connected to the intermediate apparatuses 101 via, for example, the Internet 103. An alternative network such as a public line may also be used. In this way, the management system 102 remotely manages each of the managed apparatuses 10 via the intermediate apparatuses 101 in a centralized manner. The intermediate apparatuses 101 and the managed apparatuses 10 form various hierarchical structures in accordance with environment in which they are used.

For example, an installation environment A as shown in FIG. 1 has a simple structure where the intermediate apparatus 101a, which can establish direct connection with the management apparatus 102 by Hyper Text Transfer Protocol (HTTP), is connected to the managed apparatuses 10a and 10b. On the other hand, in an installation environment B as shown in FIG. 1, four managed apparatuses 10 (10c, 10d, 10e, and 10f) are installed. If only one intermediate apparatus 101 is installed, the processing load becomes heavy on the apparatus. For this reason, in the installation environment B, a hierarchical structure is formed. The intermediate apparatus 101b, which can establish direct connection with the management apparatus 102 by HTTP, is connected to another intermediate apparatus 101c, and the intermediate apparatus 101c is further connected to the managed apparatuses 10e and 10f. In this case, information transmitted from the management apparatus 102 for remotely managing the managed apparatuses 10e and 10f arrives at the managed apparatus 10e or 10f via the intermediate apparatus 101b and the intermediate apparatus 101c, which is a lower level node of the intermediate apparatus 101b.

In addition, as in an installation environment C, managed apparatuses 11a and 11b have intermediate functions (hereinafter also simply referred to as “managed apparatus”). The managed apparatuses 11a and 11b having the functions of an intermediate apparatus 101 may be connected to the management apparatus 102 via the Internet 103 without an intermediate apparatus. It is also possible to further connect a managed apparatus that is equivalent to the managed apparatus 10 to the managed apparatus 11 having intermediate functions, although the diagram fails to show such an arrangement.

Further, it should be noted that firewalls 104 (104a, 104b and 104c) are installed in the respective environments A, B and C for security. In the remote management system, the communication terminal at the factory E is connected to the central management device at the service center S as will be described later. In such a remote management system, the intermediate apparatuses 101 run an application program for controlling and managing the managed apparatuses 10 that are connected with the intermediate apparatuses 101.

The central management apparatus 102 installs an application program for controlling and managing each of the intermediate apparatuses 101 and for further controlling and managing the managed apparatuses 10 via the intermediate apparatuses 101. Each of the nodes in the remote management system, including the managed apparatuses 10, is capable of transmitting a “request” by remote procedure call (RPC) for processing in accordance with a method of the application program installed in each node and obtaining or receiving a “response” that is the result of the requested process by the RPC.

That is, the intermediate apparatuses 101 or the managed apparatuses 10 connected thereto are generating a request to the management apparatus 102, transmitting the request to the management apparatus 102, and obtaining the response to the request. Similarly, the management apparatus 102 is generating a request, transmitting the same to the intermediate apparatuses 101 and obtaining the response to the request. The above requests include a request for causing the intermediate apparatuses 101 to transmit various other requests to the managed apparatuses 10 and to obtain responses from the managed apparatuses 10 via the intermediate apparatuses 101. Furthermore, in order to implement the RPC, well known communication protocols, techniques, specifications and the like are used and include SOAP (Simple Object Access Protocol), HTTP, FTP (File Transfer Protocol), COM (Component Object Model), and/or CORBA (Common Object Request Broker Architecture).

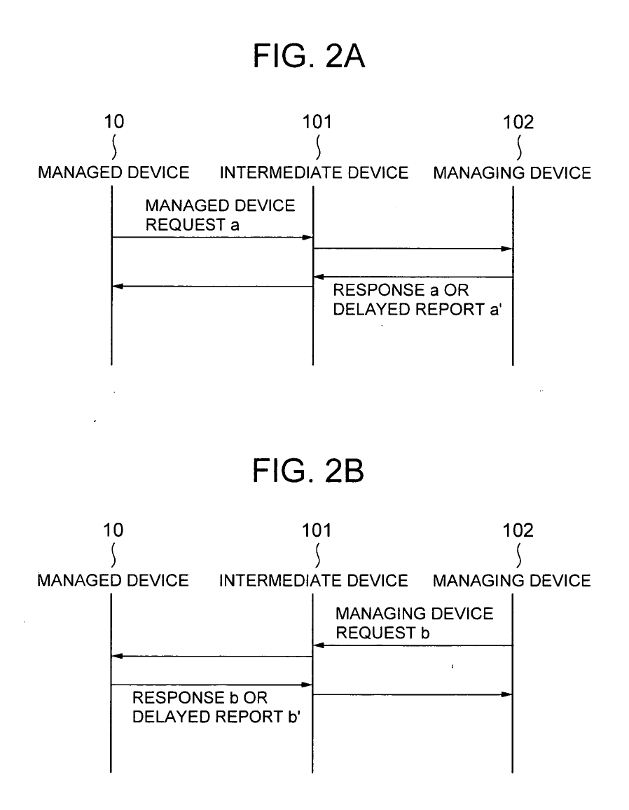

FIGS. 2A and 2B are conceptual diagrams illustrating data transmission and reception models of the above-mentioned transmission and reception. No firewalls 104 are considered in the conceptual diagrams. FIG. 2A illustrates a case where a request to the management apparatus 102 is generated at one of the managed apparatuses 10. The model in this case is as follows: the managed apparatus 10 generates a “request from the managed apparatus a”, and the management apparatus 102, receiving the request via the intermediate apparatus 101, returns a “response a.” The present invention also contemplates the case where the number of intermediate apparatuses 101 shown in FIG. 2A is two or more as in the installation environment B in FIG. 1. It should be noted that FIG. 2A shows the case where a “response delay notification a'” is returned in addition to the “response a.” This is because the management apparatus 102 is configured such that, when it is determined that the response to the request cannot be returned immediately in response to reception of the “request from the managed apparatus” via the intermediate apparatus 101, the response delay notification is transmitted and the connection is temporarily disconnected. The response to the request is then given later in a subsequent connection.

FIG. 2B illustrates a case where a request to the managed apparatus 10 is generated by the management apparatus 102. The model in this case is as follows: the management apparatus 102 generates a “request from the management apparatus b”, and the managed apparatus 10 which receives this request via the intermediate apparatus 101 returns a “response b.” In addition, similar to the case of FIG. 2A, in the case of FIG. 2B, a “response delay notification b'” is returned when the response cannot be returned immediately.

Next, a brief description will be given for an exemplary embodiment of the management apparatus 102 as shown in FIG. 1. The management apparatus 102 is constructed of a CPU, a ROM, a RAM, a non-volatile memory, a network interface card (hereinafter referred to as a “NIC”), and the like. A detailed description of the construction will be given later. Additionally, a brief description will be given for an exemplary embodiment of the intermediate apparatus 101 as shown in FIG. 1. The intermediate apparatus 101 is constructed of a CPU, a ROM, a RAM, a nonvolatile memory, NIC and the like. A detailed description of the construction will be given later.

Further, for the managed apparatus 11 having intermediate functions, the above-mentioned units or components may be simply added to the managed apparatus 10 so as to realize the functions of the intermediate apparatus 101. However, it is also possible to realize the functions of the intermediate apparatus 101 by using hardware resources provided to the managed apparatus 10, such as a CPU, a ROM, a RAM and the like, and causing the CPU to execute an appropriate application or a program module. Next, a description will be given for an image forming apparatus management system according to the present invention. The remote management system has an image forming apparatus or electronic apparatus as the managed apparatus. Such image forming apparatus is a more specific example of the remote management system as shown in FIG. 1.

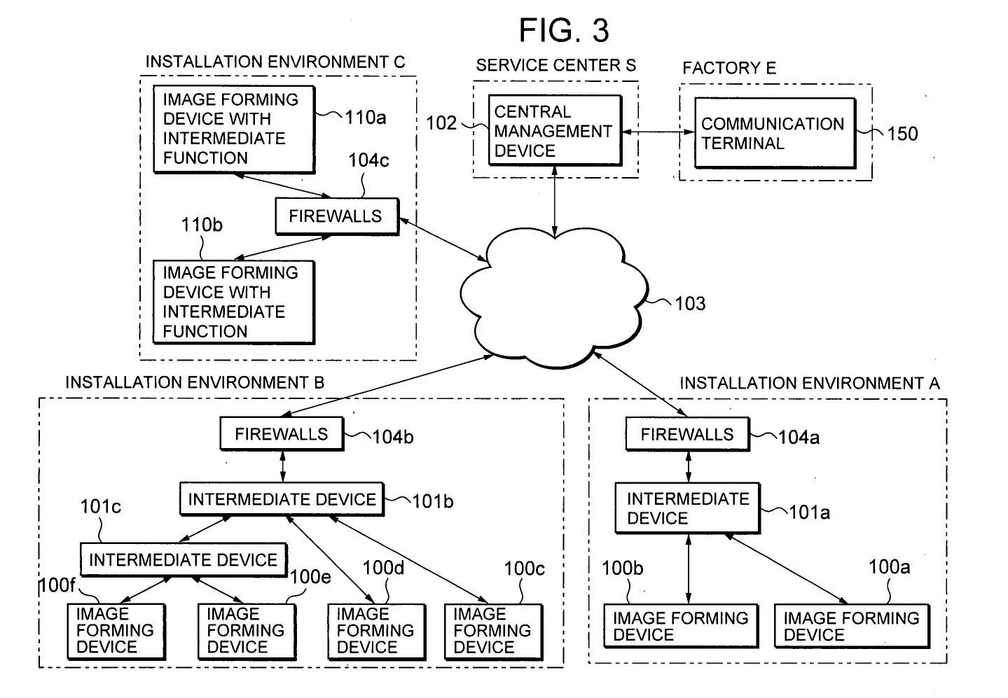

FIG. 3 is a conceptual diagram illustrating a preferred embodiment of the image forming apparatus management system according to the current invention. A description of the structure of the system will be given only to the extent that FIG. 3 differs from FIG. 1 in that the managed apparatuses 10 are changed to image forming apparatuses 100 and the managed apparatuses 11 with intermediate functions are changed to image forming apparatuses 110 having intermediate functions (hereinafter also referred to as “image forming apparatuses”). The image forming apparatuses 100 are digital multi-functional apparatuses having functions of devices such as a copying machine, facsimile apparatus, scanner, and the like and functions for communicating with an external apparatus. The image forming apparatuses 100 install an application program for providing services relating to the above-mentioned functions. In addition, the image forming apparatuses 110 having the intermediate functions are the image forming apparatuses 100 having the functions of the intermediate apparatuses 101.

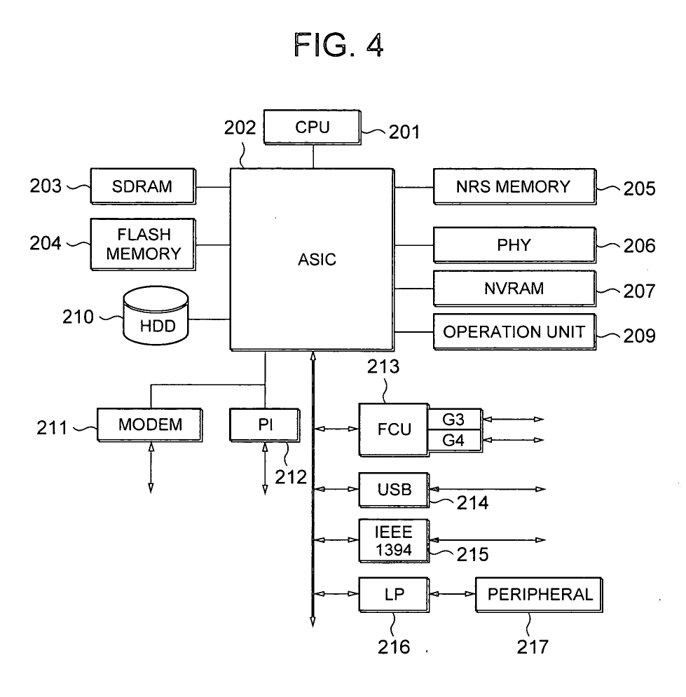

Referring to FIG. 4, a description will be given for a preferred embodiment of the image forming apparatus 100 according to the current invention. FIG. 4 is a block diagram illustrating a preferred embodiment of the physical construction of the image forming apparatus 100. As shown in FIG. 4, the image forming apparatus 100 includes a central processing unit 201 (hereinafter also referred to as a “CPU”), an application specific integrated circuit (ASIC) 202, a SDRAM 203, a non-volatile flash memory unit 204, a NRS memory unit 205, a physical media interface (PHY) 206, a NVRAM (nonvolatile RAM) 207, an operation panel 209, a hard disk drive (HDD) 210, a modem 211, a PI (personal interface) board 212, a fax control unit (FCU) 213, universal serial bus (USB) 214, IEEE 1394 215, a LP reading/writing unit 216 and other peripheral apparatus 217. The CPU 201 is a calculation means to perform data processing or function controlling via the ASIC 202. The ASIC 202 is a multi-functional device board and includes a CPU interface, a SDRAM interface, a local bus interface, a PCI interface, a media access controller (MAC) and a HDD interface. The ASIC 202 provides a device common ownership and supports the effective development of the interchangeable system service and application software programs.

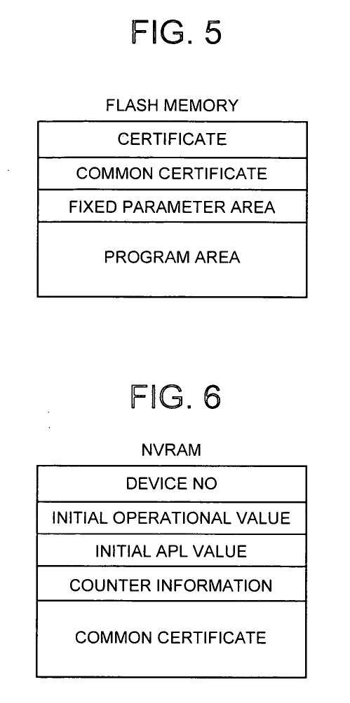

Various memory units will be described. The SDRAM 203 is a main memory unit for providing a work memory area for the CPU 201 to perform the data processing as well as a program memory area for storing the operating system (OS) and other application programs. The SDRAM 203 may be replaced by DRAM or RAM. The flash memory 204 is non-volatile and stores the information even after power is off. The flash memory 204 includes a program memory area for storing OS files for OS images a boot loader for activating the image forming device 100 as will be described with respect to FIG. 5. The flash memory 204 also includes a certificate memory area for storing digital certificates to be used for mutual confirmation by the SSL during the communication with the central management device 102. The flash memory 204 further includes a common certificate memory area for storing common digital certificates to be used by the SSL for mutual confirmation in order to implement each service. Lastly, the flash memory 204 includes a fixed parameter memory area for storing various fixed parameters. The flash memory 204 may be replaced by a non-volatile memory unit such as a non-volatile RAM back-up circuit with a RAM and batteries or EEPROM. The NRS memory unit 205 is non-volatile memory for storing NRS to be later described and adds optional NRS functions. The PHY 206 is an interface for communicating with an external device via LAN. The NVRAM 207 is non-volatile and stores the information even after power is off. The NVRAM 207 includes a device number memory area for storing device numbers for identifying the image forming apparatus 100 and a memory area for storing initial operational values for the operation unit 209. The NVRAM 207 may be replaced by a non-volatile memory unit such as a non-volatile RAM back-up circuit with a RAM and batteries or EEPROM. The operation unit 209 is a operation display unit. The HDD 210 is a storage media for storing data regardless of the power status. The HDD 210 stores programs of the above described flash memory unit 204, other programs or the data of the NVRAM 207.

Still referring to FIG. 4, other components of the image forming apparatus 100 according to the current invention will be described. The modem 211 is a modulation means. When data is transmitted to the central management apparatus 102 via the public line, the data is modulated to transmit on the public line. When the modulated data is received from the central management apparatus 102, the data is demodulated. The PI 212 has an interface according to the RS485 standard and is connected to the public line via a line adapter although it is not shown in FIG. 4. The FCU 213 controls the communication via the communication line with external devices such as the central management apparatus 102 and the image forming apparatus such as digital copiers and digital multi-functional machines having a facsimile unit or a modem function. The CPU 201 activates the boot loader in the flash memory 204 via the ASIC 202 upon the power activation. According to the boot loader, the OS images are read from the flash memory 204 and are loaded in the SDRAM 203 to prepare a functional operating system. After completing the OS, the OS is activated. Subsequently, depending upon necessity, programs such as application programs are read from the flash memory unit 204. NRS are also read from the NRS memory unit 205 into the SDRAM 203 depending upon the subsequent necessity. Various functions are implemented by the above read program data that are executed in the SDRAM 203.

Now referring to FIG. 5, a table illustrates an exemplary content of the flash memory unit 204 to be used with the current application. The flash memory unit 204 includes information such as a certificate and a common certificate, fixed parameters and computer programs in separate areas as shown. The above exemplary content of the flash memory unit is a partial illustration, and the flash memory content is not limited to the described usage.

Similarly, referring to FIG. 6, a table illustrates an exemplary content of the non-volatile random access memory (NVRAM) unit 207 to be used with the current application. The NVRAM unit 207 includes information such as a device number, an initial operational value, an initial application value, counter information and common certificate information. The above exemplary content of the NVRAM unit is a partial illustration, and the NVRAM content is not limited to the described usage.

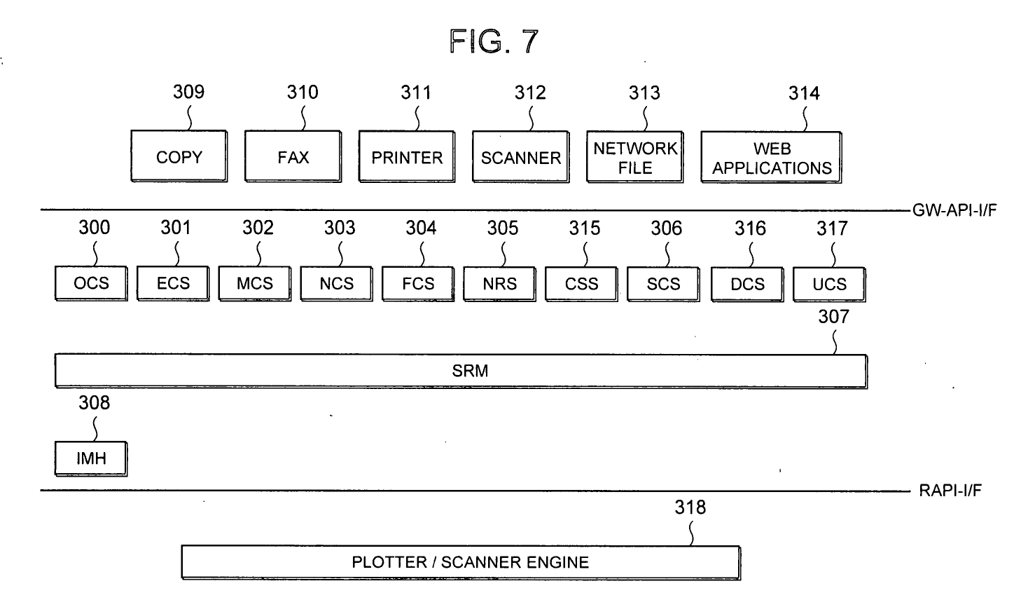

Now referring to FIG. 7, a block diagram illustrates an example of the software configuration of the image forming apparatus 100 according to the current invention. The software configuration of the image forming apparatus 100 is formed by an application module upper layer, a service module middle layer, and a versatile OS lower layer. Programs forming the software are stored in the flash memory unit 204 or the NRS memory unit 205, are read out according to the needs, and executed by the CPU 201. The application module layer software includes programs to implement a plurality of predetermined application control and execution functions by operating the hardware resources via the CPU 201. The service module layer software exists between the CPU hardware and each of the application control means. The service module layer software receives operational requests for the hardware resources from a plurality of the application control means. Thus, the service module layer software includes programs to implement a service control means for controlling execution based upon the operational requests and for arbitrating the operational requests.

Among the above described functions, the implementation method of communicating with the central management apparatus 102 depends upon the image forming apparatus 100 and the image forming apparatus 110 with the intermediate function. That is, since the image forming apparatus 110 includes the intermediate function, the CPU executes the corresponding program to implement the communication function with the central management apparatus 102. On the other hand, in the case of the image forming apparatuses 100, it is possible to realize the functions relating to communication with the management apparatus 102 by executing the corresponding program by the controller CPU and by using the intermediate apparatuses 101.

The service module layer includes an operation control service (OCS) 300, an engine control service (ECS) 301, a memory control service (MCS) 302, a network control service (NCS) 303, a FAX control service (FCS) 304, a new remote service (NRS) 305, a system control service (SCS) 306, a system resource manager (SRM) 307, an image memory handler (IMH) 308, a customer support system (CSS) 315, a delivery control service (DCS) 316, and a user control service (UCS) 317. Also, the application module layer includes a copy application 309, a FAX application 310, a printer application 311, a scanner application 312, a Net File application 313, and a web application 314.

A more detailed description of the above-mentioned modules and applications will be given below. The OCS 300 is a module for controlling the operation panel 209. The ECS 301 is a module for controlling the engine unit such as the hardware resources. The MCS 302 is a module for performing memory control. For example, the MCS 302 obtains and releases image memory, and uses the HDD 201. The NCS 303 is a module for performing an intermediate process between a network and each application program in the application module layer. The FCS 304 is a module for performing facsimile transmission and reception, facsimile reading, facsimile reception and printing, and the like. The NRS 305 is a module for converting data to be transmitted via the network. The NRS 305 also includes combined modules for providing the functions related to the remote management to communicate with the central management apparatus 102 via the network. The SCS 306 is a module for the activation and deactivation management of each application program in the application module layer based upon the contents of a command. The SRM 307 is a module for performing system control and resource management. The IMH 308 is a module for managing memory which temporarily stores image data.

The CSS 315 is a module for converting data upon transmitting and receiving the data over a public line. The CSS 315 is a module that organizes functions related to the remote management over the public line. The DCS 316 is a module for transmitting and receiving an image file or the like stored (to be stored) in the HDD 201 or the memory on the controller board 200 by using SMTP (Simple Mail Transfer Protocol) or FTP (File Transfer Protocol). The UCS 317 is a module for managing user information, such as destination information and address information that are registered by a user of the apparatus. The copy application 309 is an application program for realizing copy service. The FAX application 310 is an application program for realizing FAX service. The printer application 311 is an application program for realizing printer service. The scanner application 312 is an application program for realizing scanner service. The Net File application 313 is an application program for realizing Net File service. The web application 314 is an application program for realizing web service.

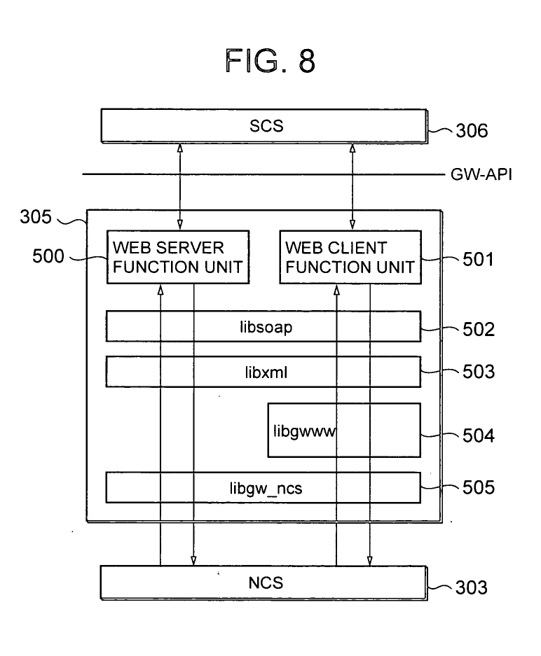

Now referring to FIG. 8, a functional block diagram illustrates one preferred embodiment of the modules of the NRS 305. As shown in FIG. 8, the NRS 305 performs processes between the SCS 306 and the NCS 303. A web server function part 500 performs a response process for a request received from the outside. The request may be, for example, a SOAP request according to the SOAP (Simple Object Access Protocol) described in a structured language such as the XML (Extensible Markup Language) format. The web client function part 501 performs a process of issuing a request to the outside. A libsoap 502 is a library that processes data in the SOAP format. A libxml 503 is a library that processes data described in the XML format. In addition, a libgwww 504 is a library that processes data in the HTTP format. A libgw_ncs 505 is a library that performs processes with respect to the NCS 303.

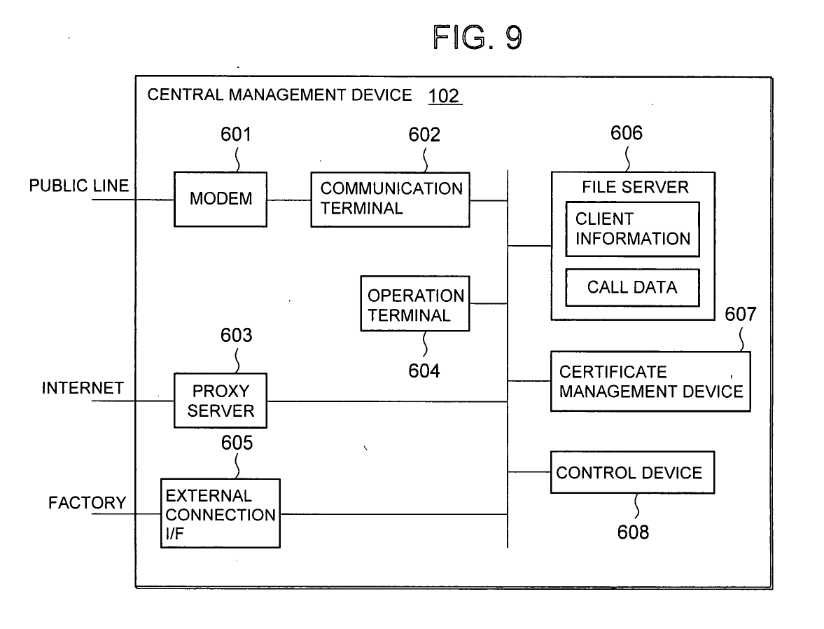

FIG. 9 is a block diagram showing an example of the components of the central management apparatus 102. The management apparatus 102 includes a modem 601, a communication terminal 602, a proxy server 603, an operator terminal 604, an external communication interface (I/F) 605, a file server 606, a digital certificate management device or certificate management device 607, a control unit 608, and the like. The modem 601 communicates with the intermediate apparatus 101 or the image forming apparatus 110. For example, the user's destination is the image forming apparatus via a public line. The modem 601 respectively modulates and demodulates transmission data and reception data. The modem 601 serves as communication means together with the communication terminal 602, which will be described later. The communication terminal 602 controls data transmission and reception between the intermediate apparatus 101 and the line adapter via a public line. The proxy server 603 performs security management and communication with the intermediate apparatus 101 on the user's end via the Internet. The proxy server 603 also serves as the communication means.

The operator terminal 604 is a terminal that the management center operator operates. The operator terminal 604 accepts inputs of various data via an input device such as a keyboard when an operation is conducted thereon by the user and displays the information to be reported to the operator. The input data includes client information such as IP addresses and telephone numbers that are used to communicate with the intermediate apparatus 101 or the image forming device 110 on the device user side. The external communication I/F 605 is an interface for communicating with the communication terminal 150 at the production factory E of FIG. 3. The file server 606 includes a memory device such as a hard disk drive that is not illustrated in the diagram. The memory device stores the IP addresses and the telephone numbers of the intermediate apparatus 101 and the image forming apparatus 110 of the each device user, data received from the above devices, data input from the operation terminal 604, device and customer databases to be described later and various data including the software programs according to the current invention. The certificate management device 607 issues the above described certificate or common certificate in response to a transmission request from the communication terminal 150 at the factory E. The certificate management device 607 then transmits the issued certificates to the central management apparatus 102. This aspect will be later further described.

The control device 608 further includes a microcomputer with a CPU, a ROM and a RAM although it is not illustrated in the diagram. The control device 608 controls the central management apparatus 102 in an overall manner. The CPU in the control device 608 operates according to the above described software programs or executes the software programs according to the needs. The CPU also selectively utilizes the modem 601, the communication terminal 602 or a proxy server 603 to perform various processes.

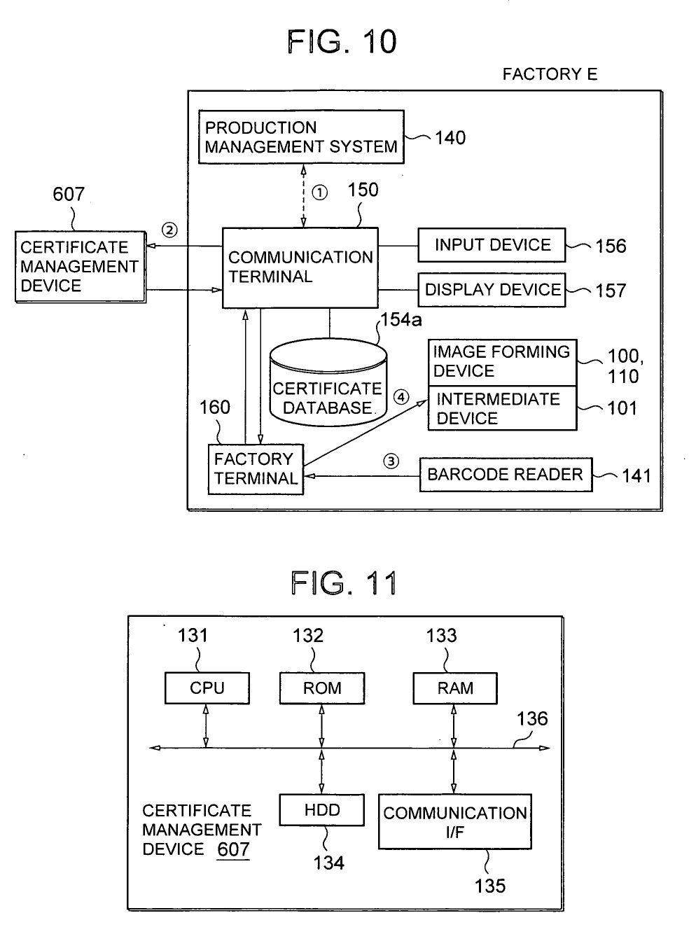

Now referring to FIG. 10, a block diagram illustrates components of the factory E in a preferred embodiment according to the current invention. The factory E includes a production management system 140, a communication terminal 150 and a factory terminal 160. The production management system 140 manages a daily production number of communication devices such as the image forming apparatus 100/110 and the intermediate device 101. The daily production number alternatively includes a control panel of the above described communication devices. The communication terminal 150 obtains the daily production numbers along with the serial numbers and the device code for each device with a distinct device number from the production management system 140. Then, the communication terminal 150 obtains necessary certificates from the certificate management device or the certificate authority 607 in the central management apparatus 102 based upon the above described information. The factory terminal 160 obtains a corresponding certificate for a device from the communication terminal 150 in response to a device number that is inputted by a barcode scanned by a barcode reader 141. The factory terminal 160 transmits the certificate to the corresponding communication device and writes the certificate to a non-volatile memory of the communication device. The communication terminal 150 and the factory terminal 160 form the information processing device according to the current invention. The barcode reader 141 is a scanner for scanning the barcode information indicative of the device number or the identification information on the check sheet or the predetermined name plate on the communication device. The barcode reader 141 then transmits the scanned information to the factory terminal 160. The barcode reader 141 includes a small portable barcode reader.

Referring to FIG. 11, a block diagram illustrates components of the certificate management device 607 in the preferred embodiment according to the current invention. The certificate management device 607 further includes a CPU 131, a ROM 132, a RAM 133, a HDD 134 and a communication I/F 135, and these components are interconnected by a bus 136. The certificate management device 607 controls the operation according to the CPU by executing various control programs stored in the ROM 132 or the HDD 134 and implements the functions for a digital certificate generation means and a digital certificate transmission means.

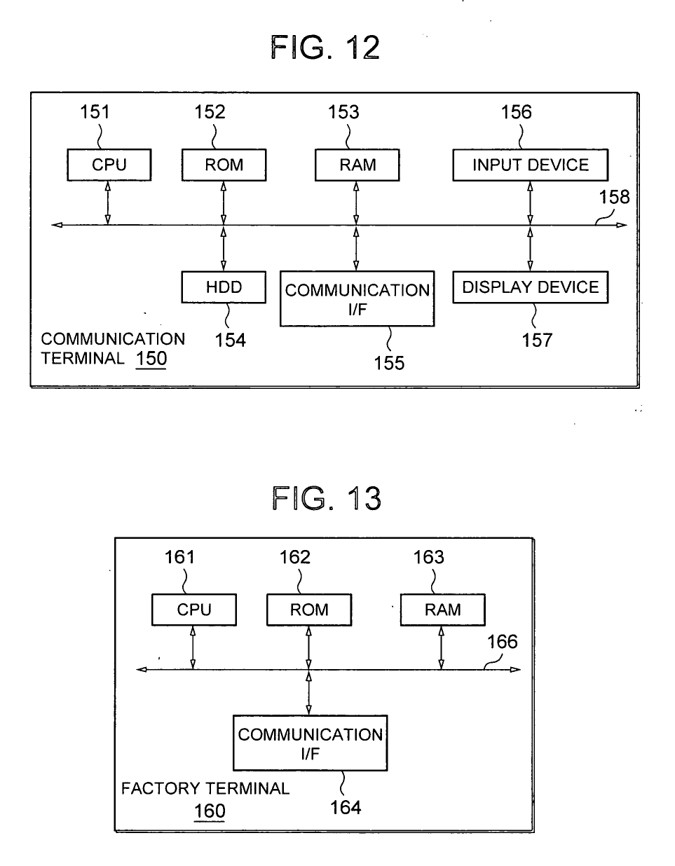

Referring to FIG. 12, a block diagram illustrates hardware components of the communication terminal 150 in the preferred embodiment according to the current invention. The communication terminal 150 includes a CPU 151, a ROM 152, a RAM 153, a HDD 154, a communication I/F 155, an input device 156 and a display device 157, and these components are interconnected by a bus 158.

Referring to FIG. 13, a block diagram illustrates hardware components of the factory terminal 160 in the preferred embodiment according to the current invention. The communication terminal 150 includes a CPU 161, a ROM 162, a RAM 163 and a HDD 164, and these components are interconnected by a bus 166.

With respect to FIGS. 12 and 13, according to the communication terminal 150 and the factory terminal 160, the CPU 151 executes the programs stored in the ROM 152 or the HDD 154 to control the communication terminal 150. Similarly, the CPU 161 executes the programs stored in the ROM 162 to control the communication terminal 160. The above described operations implement the following functions according to the current invention, including a digital certificate transmission request means, a digital certificate transmission means, a digital certificate storage means, a written information setting means and a digital certificate deleting means. For the hardware of the certificate management device 607, a communication terminal 150 and a factory terminal 160, a computer is used or any other hardware is added.

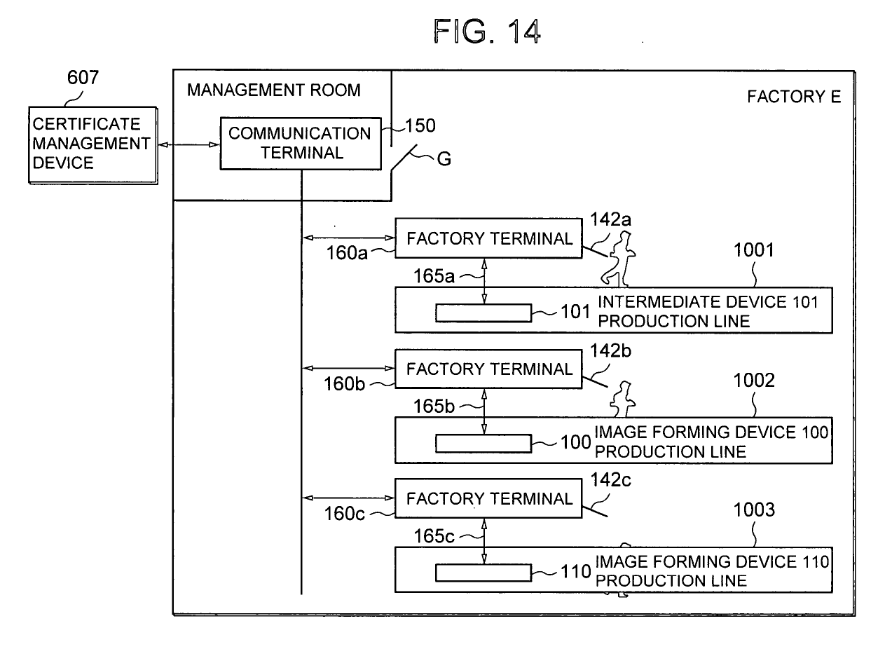

Now referring to FIG. 14, a block diagram illustrates peripheral devices around the communication terminal 150 and the factory terminal 160 at the production factory E according to the current invention. The communication terminal 150 is located in an administration room F at the production factory E for the security reasons. Only predetermined managers have access to the administration room F by a lock on the door. Furthermore, the communication terminal 150 is operational only when a predetermined ID and password are inputted. In this example, the production factory E includes a first production line 1001 for,the intermediate device 101, a second production line 1002 for the image forming device 100 and a third production line 1003 for the image forming device 110. Factory terminals 160 including 106a, 160b and 160c are respectively located at the first, second and third production lines 1001, 1002 and 1003. Each of the factory terminals 106a, 160b and 160c is respectively connected to barcode I/F's 142a, 142b and 142c for the connection with barcode readers 141a, 141b and 141c. Similarly, each of the factory terminals 106a, 160b and 160c is respectively connected to a writing I/F 165a, 165b and 165c for the connection with the communication devices such as the intermediate device 101 and the image forming device 100, 110.

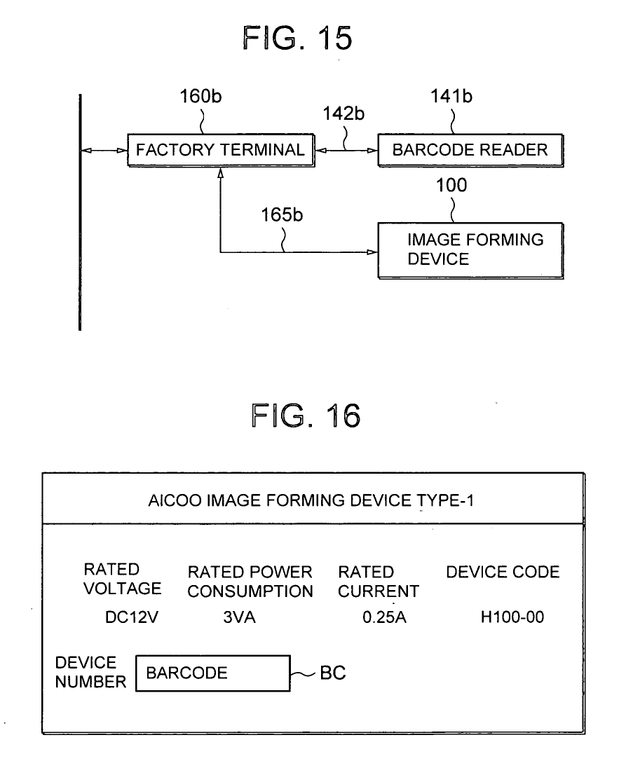

Now referring to FIG. 15, a diagram illustrates the exemplary connections among the factory terminal 160, the barcode reader 141 and the communication device according to the current invention. As described above, the factory terminal 160b is connected to the barcode reader 141b via the barcode I/F 142b. Similarly, the factory terminal 160b is connected to the image forming device 100 via the writing I/F 165. The image forming device 100, the image forming device 110 and the intermediate device 101 have the same IP address as an initial value. When the factory terminal 160 and the LAN are connected, since the IP address is duplicated, the factory terminal 160 is connected using a cross cable or the writing I/F 165.

FIG. 16 is a diagram illustrating one exemplary rated inscription plate attached to the image forming device 100 or 110 according to the current invention. The barcode reader 141 scans the barcode BC information indicative of the device number on the rated inscription plate. The rated inscription plate also includes information on the rated voltage, the rated power consumption, the rated current and the device code for the image forming device TYPE-1.

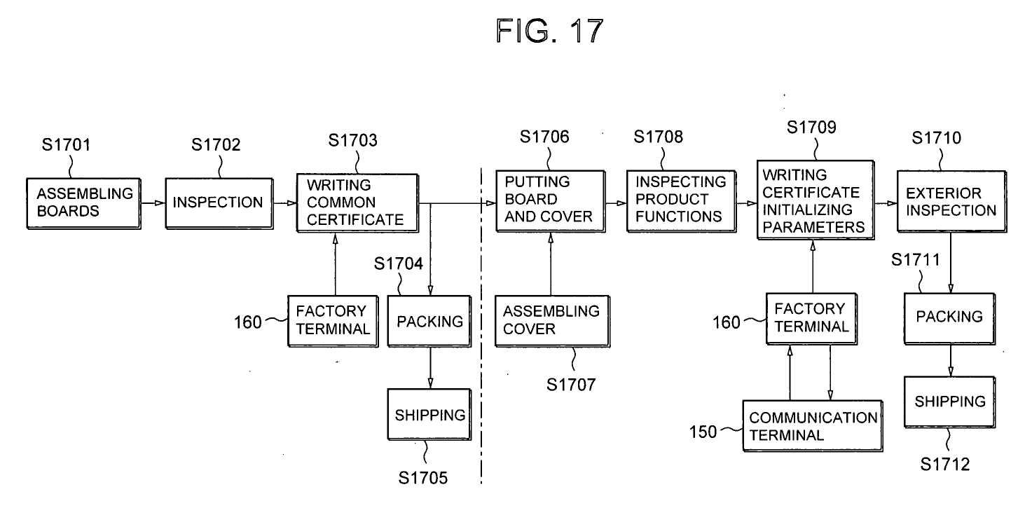

FIG. 17 is a diagram illustrating exemplary production steps of producing the communication device at the first, second and third production lines 1001, 1002 and 1003 at the production factory E of FIG. 14. At each of the first, second and third production lines 1001, 1002 and 1003, the control board is first assembled in a step S1701 for the communication devices such as the intermediate device 101 and the image forming device 100/110. Subsequently, after the control boards are inspected in a step S1702, a fixed value is written by the factory terminal 160 to the flash memory 204 or the NVRAM 207 as a common certificate in a step S1703. The control boards with the common certificate written in the flash memory 204 or the NVRAM 207 are packed in a step S1704 and shipped as service parts in a step S1705. Alternatively, the control boards with the common certificate written in the flash memory 204 or the NVRAM 207 are sent to a next step S1706 to generate products. The covers are assembled in advance in a step S1707 for the image forming device 100 or 110. In the step S1706, the control boards are placed on the covers to be installed in the image forming device 100 or 110 for the finished product. The inspection is performed for the functions of the product image forming device 100 and 110 in a step S1708. After the inspection, in a step S1709, the communication terminal 150 and the factory terminal 160 write the certificate in the flash memory 204, and the parameters in the flash memory 204 are initialized. The exterior of the product image forming device 100 and 110 is inspected in a step S1710. Lastly, the product image forming device 100 and 110 is packaged and shipped respectively in steps S1711 and S1712. The steps S1706 through S1712 of the product assembly often take place at a factory that is different from the initial board assembling factory.

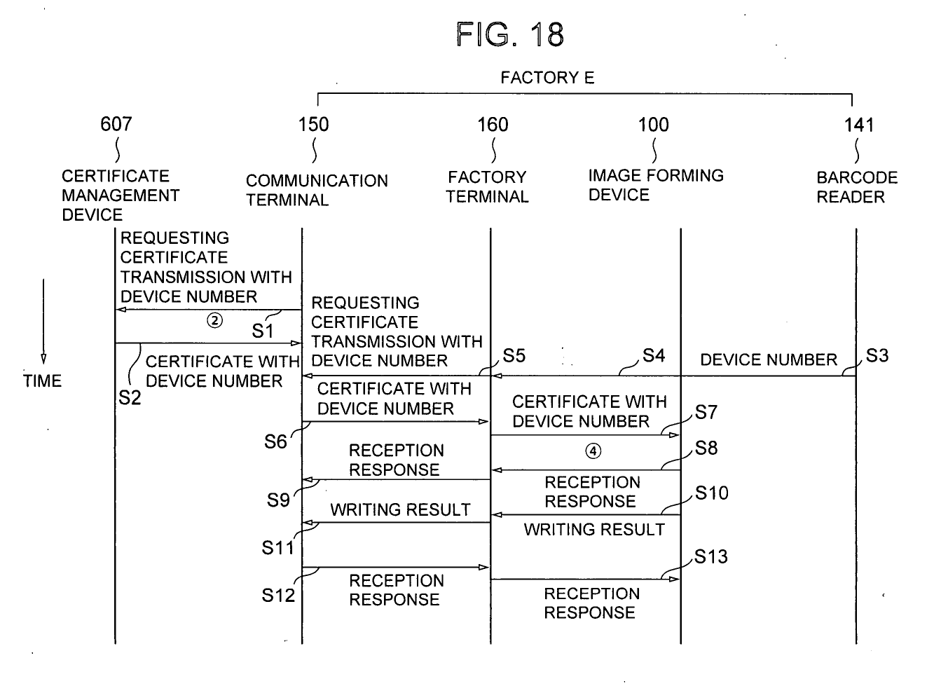

FIGS. 18 through 23 will be described with respect to a preferred embodiment of the image forming device management system or the image management system for obtaining certificates according to the current invention.

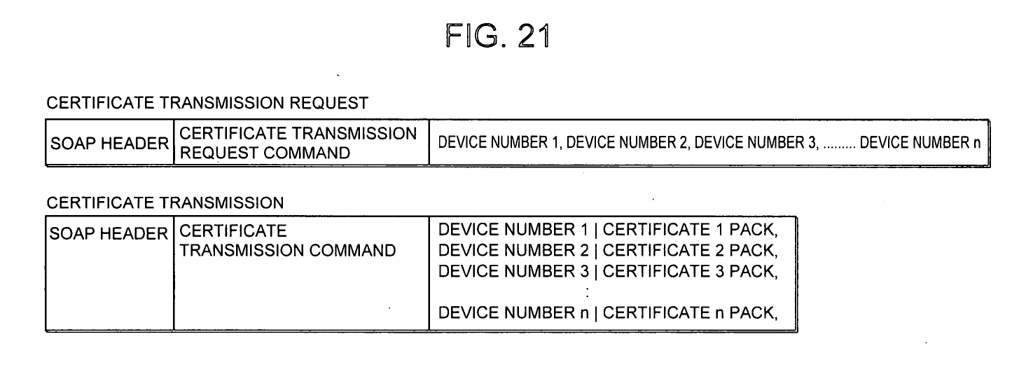

In particular, FIG. 18 illustrates an exemplary pseudo timing chart or sequence for obtaining certificates for the image forming device management system. At the factory E, the communication terminal 150, the factory terminal 160, the image forming device 100 and the barcode reader 141 are located. The CPU 151 of the communication terminal 150 obtains a number of daily production units for each of the communication device such as the image forming device 100 from the production management system 140 at a predetermined timing each month. The communication terminal 150 stores the retrieved certificates in the production plan database in the HDD 154 to update the production plan DB. Based upon the certificate management device list DB and the production plan DB in the HDD 154, at the predetermined time everyday, the transmission request is reported to the certificate management device 607 also in a step S1. The transmission request is for the certificate to be used for the SSL mutual confirmation during communication by each of the communication devices that have been produced today. To the communication request, the identification number or device number of the corresponding communication device is added for the today's productions. Alternatively, a communication request is reported for each one of the communication devices. In response to the certificate transmission request from the communication terminal 150, the CPU 131 of the certificate management device 607 generates the certificates according to the number of the devices for the device number which is included in the request. The certificate management device 607 transmits each of the generated certificates to the communication terminal 150 in a step S2. After the communication terminal 150 and the certificate management device 607 confirm with each other based upon the SSL using the common certificate, they communicate with each other via SSL using the SOAP data format or the XXL structured language format as shown in FIG. 21.

After the transmission request with the device numbers to the certificate management device 607 and upon receiving the certificates each including the device number from the certificate management device 607, the CPU 151 of the communication terminal 150 updates a certificate DB 154a by storing the received certificates in the certificate DB 154a at the HDD 154. The barcode reader 141 transmits the scanned barcode information to the communication device of the image forming device 100 in a step S3, and the image forming deice 100 in turn transmits the scanned information to the factory terminal 160 in a step S4. The CPU 161 of the factory terminal 160 sequentially transmits in a step S5 to the communication terminal 150 a transmission request for a certificate that includes a device number indicated by a barcode on the rated inscription plate or a corresponding check sheet of the communication device that has been produced on that day. The CPU 151 of the communication terminal 150 reads a corresponding certificate from the certificate DB of the HDD 154 and transmits the certificate to the factory terminal 160 in a step S6 upon receiving the certificate transmission request with a device number as indicated by a barcode from the factory terminal 160 in the step S5. After the transmission request with the device numbers to the communication terminal 150 and upon receiving the certificates, the CPU 161 of the factory terminal 160 further transmits in a step S7 the certificates to corresponding ones of the communication devices as located in the image forming devices 100 whose device number has been scanned as shown by an arrow near the circled number 4. Upon receiving the certificate from the factory terminal 160, the communication device CPU transmits a reception response back to the factory terminal 160 in a step S8 and then writes the certificate in an internal non-volatile memory such as the flash memory 204 of the image forming apparatus 100. Upon receiving the reception response from the communication device for the certificate transmission to the corresponding communication device, the factory terminal 160 in turn transmits the received reception response to the communication terminal 150 in a step S9. If the above write is confirmed successful, the certificate writing completion result is reported to the factory terminal 160 in a step S10 to indicate a successful completion. Contrarily, if the above write is not confirmed successful, the certificate writing completion result is reported to the factory terminal 160 in the step S10 to indicate a failed completion. Subsequently, upon receiving the write completion result, the CPU 161 of the factory terminal 160 also transmits the received write completion result to the communication terminal 150 in a step S11.

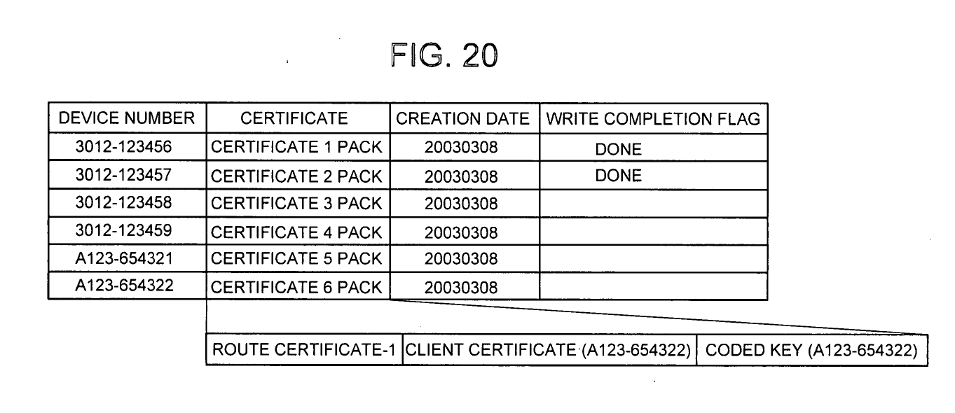

After transmitting the certificate to the factory terminal 160 and upon receiving the reception response and the write completion result from the factory terminal 160, the CPU 151 of the communication terminal 150 first sends a reception response back to the factory terminal 160 in a step S12. The factory terminal 160 transmits the reception response to the image forming device 100 in a step S13 upon receiving the reception response from the communication terminal 150. Based upon the received write completion result, if the CPU 151 of the communication terminal 150 confirms that the certificate write has been completed, the CPU 151 sets a value of the write completion flag to “1” indicative of the completed writing of the corresponding certificate in the certificate DB 154a as illustrated in FIG. 20. On the other hand, if the CPU 151 confirms that the certificate write has been failed, the CPU 151 transmits a certificate transmission request including the corresponding device number to the certificate management device 607. After a new copy of the certificate is obtained in the above described manner, the certificate management device 607 transmits the newly obtained certificate to the communication terminal 150 to perform the above described processes.

For the security of the certificates, the certificates are maintained only for a certain amount of time. If the same certificate is stored in the certificate DB 154a for a long period of time, after the write completion result is received from the factory terminal 160, the certificate management device 607 deletes the corresponding certificate from the certificate DB 154a. The CPU 161 of the factory terminal 160 transmits a reception response to a corresponding communication device upon receiving the reception response from the communication terminal 150 in response to the reception response or the write completion result from the communication terminal 150.

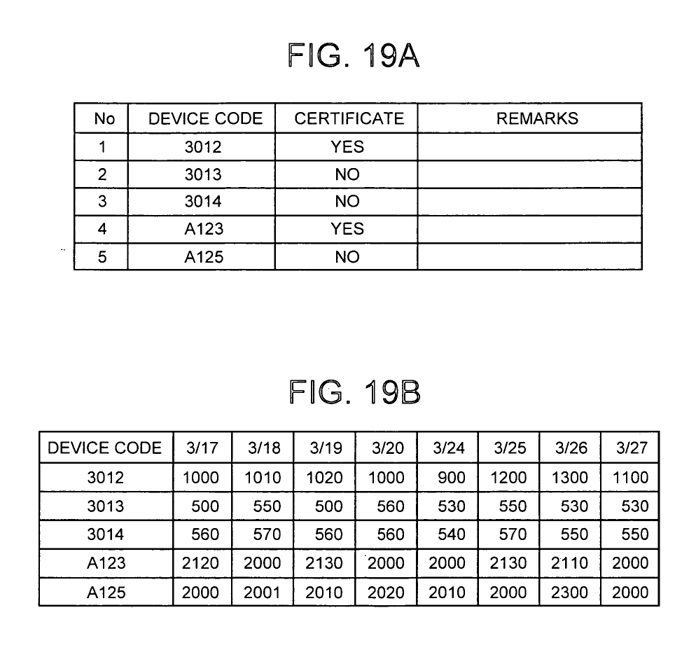

Now referring to FIGS. 19A and 19B, tables illustrate exemplary contents of the factory production management database that is stored in the HDD 154 of the communication terminal 150 according to the current invention. FIG. 19A is a table illustrating the database content for the certificate management device list. For each device, the list indicates whether or not a corresponding certificate exists. For example, for the device code number 3012, the corresponding certificate exists while for the device code number 3013, the corresponding certificate does not exist in the database. FIG. 19B is a table illustrating the database content for the production plan. For each of the specified dates, a number of production units is specified for each of the devices that are identified by the device code. For example, on March 19, five hundred sixty units are to be produced for the device 3014.

FIG. 20 is a table illustrating exemplary contents of the certificate database 154a in the HDD 154 of the communication terminal 150 according to the current invention. The certificate database 154a includes information on device numbers, digital certificates, creation dates and write completion flags. Each of the digital certificates further includes a route certificate or a route key certificate, a client certificate or a client public key certificate as well as a coded key or a client private key in a single package. For example, the certificate 1 pack that is created on Mar. 8, 2003 has been written on the device number 3012-123456 as indicated by the write completion flag. On the other hand, the certificate 3 pack that is created on Mar. 8, 2003 has not yet been written on the device number 3012-123458 as indicated by the write completion flag. To illustrate the content of the certificate pack, the certificate 6 pack further includes the route certificate-1, the client certificate (A123-654322) and the coded key (A123-654322).

FIG. 21 illustrates exemplary contents and the data formats to be used for communicating with the communication terminal 150 according to the current invention. For example, a certificate transmission request further includes a SOAP header, a certificate transmission command as well as the data indicating the device number 1 through n. Another example is a certificate transmission which further includes a SOAP header, a certificate transmission command as well as the data indicating the device numbers 1 through n with the corresponding certificate packs 1 through n. Although formats between the tow examples are slightly different, the both data formats start with the SOAP header.

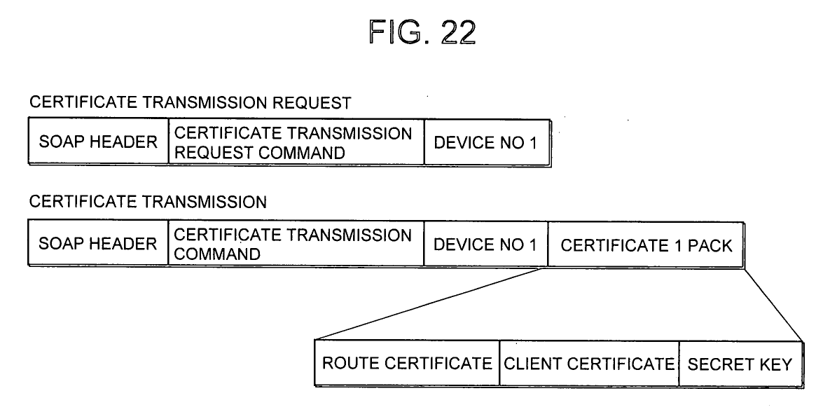

FIG. 22 illustrates exemplary contents and the data formats to be used for communicating between the communication terminal 150 and the factory terminal 160 according to the current invention. For example, a certificate transmission request further includes a SOAP header, a certificate transmission request command and a device number. Another example is a certificate transmission which further includes a SOAP header, a certificate transmission command as well as the data indicating a device number with the corresponding certificate pack. Although formats between the tow examples are slightly different, the both data formats start with the SOAP header. Furthermore, in comparison to the certificate transmission as illustrated in FIG. 21, the certificate transmission between the two terminals 150 and 160 includes data on only a single device and the corresponding certificate pack.

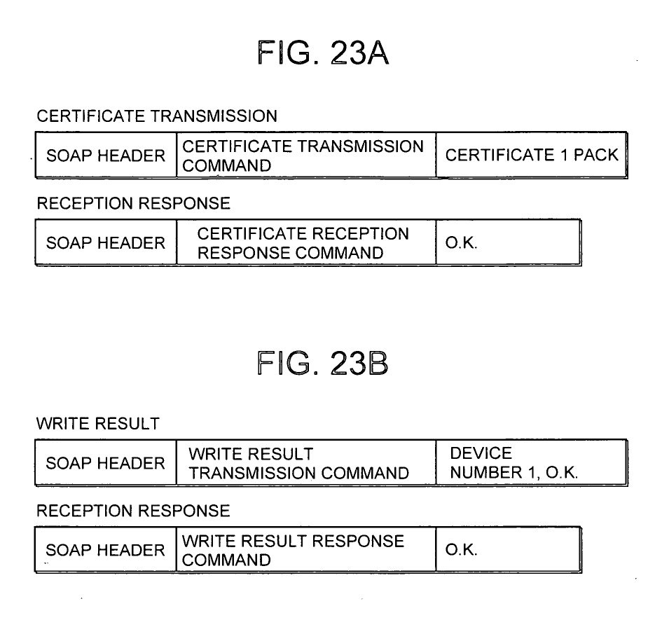

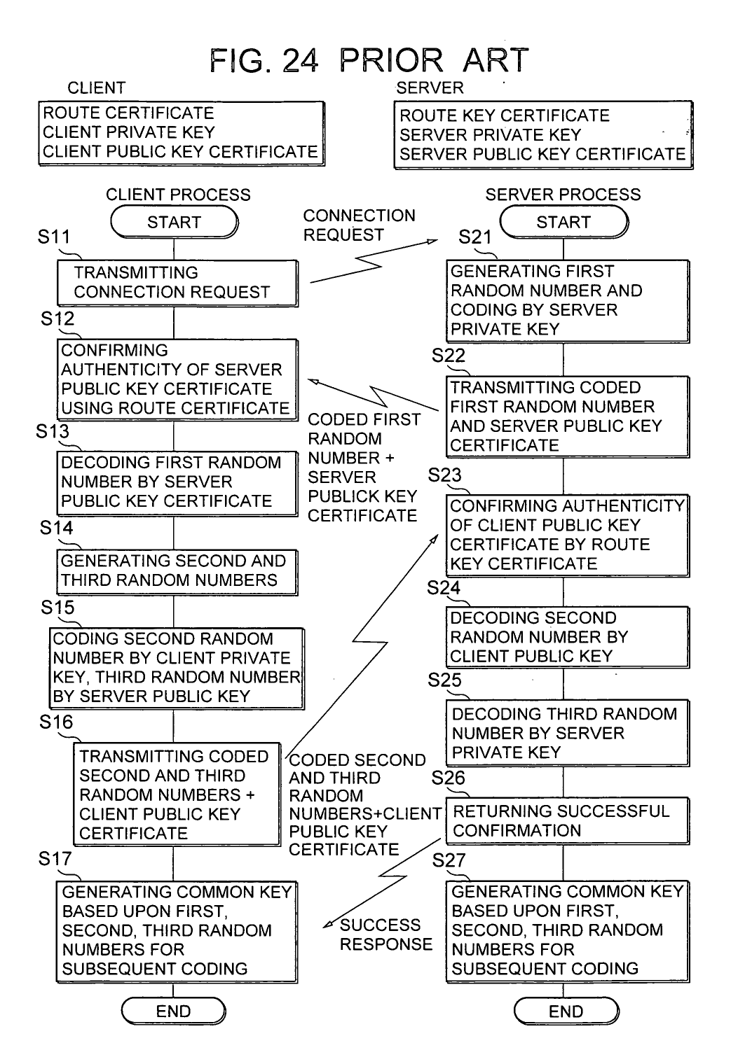

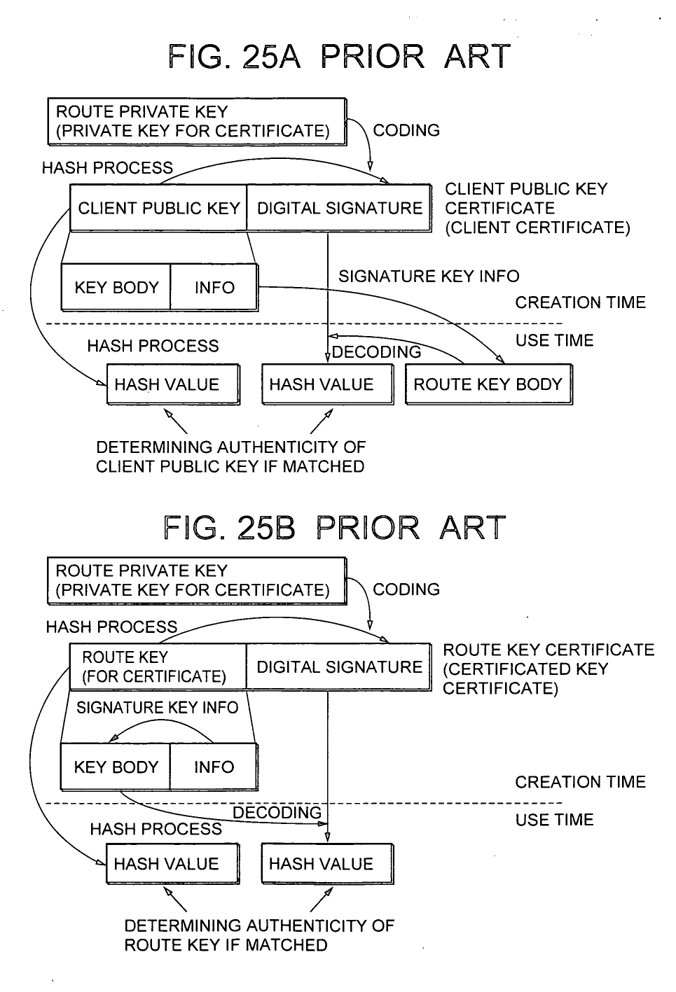

FIGS. 23A and 23B illustrate exemplary contents and the data formats to be used for communicating between the communication device such as the image forming apparatus 100 and the factory terminal 160 according to the current invention. For example, a certificate transmission request further includes a SOAP header, a certificate transmission request command and a certificate pack. In response to the certification transmission request, a reception response includes a SOAP header, a certificate reception response command and OK data. Similarly, a write result further includes a SOAP header, a write result transmission command and a device number 1 OK data. In response to the write result, a reception response further includes a SOAP header, a write result response command and OK data.

As described above, the communication terminal 150 and the factory terminal 160 communicate with each other using the SOAP data format as illustrated in FIG. 22. After the mutual confirmation is made using the SSL based upon the common certificate, the communication device communicates with the factory terminal 160 using the SOAP data format as illustrated in FIG. 23. The CPU 161 of the factory terminal 160 codes the certificate to be transmitted to the communication device, the receiving CPU of the communication device writes the coded certificate without modification or the decoded certificated in the non-volatile memory. Furthermore, in the preferred embodiment, the barcode reader scans the device number of each communication devices and inputs the scanned device number into the factory terminal 160. For example, by operating the input device 156 of the communication device 150, the device number is inputted. When the device production is discontinued, the process is performed in a planned manner. If the certificates in the certificate database of the communication terminal 150 are left for the discontinued devices, the management personnel deletes these certificates from the certificate database 154a by manually handling the communication terminal 150 of the input device 156. The CPU 151 of the communication terminal 150 displays in the display unit 157 the number of certificates that have been used for the day and the remaining number of the certificates for each device.

In the above described preferred embodiments, at least the following five effects are obtained. (1) The CPU 151 of the communication terminal 150 adds a certificate transmission request the identification information or the device numbers of the communication devices that have been produced that day and transmits the certificate transmission request to the certificate management device 607. The certificate transmission request is used for mutual confirmation during the SSL communication by the produced communication devices. In response to the device-number-added certificate transmission request, the communication terminal 150 receives the certificates each including a device number and stores the certificates in the certificate database 154a. Then, the barcode reader 141 scans the barcode indicative of device number on the rated inscription plate or check sheet attached to the communication devices that have been produced as a part of the above number of the production units. When the barcode reader 141 inputs the scanned device numbers to the communication terminal 150 via the factory terminal 160, the communication terminal 150 reads a certificate corresponding to each of the inputted device numbers from the certificate database 154a. The read certificates are transmitted via the factory terminal 160 to the above communications devices whose device numbers have been scanned. The transmitted certificate is then written to the non-volatile memory of the communication device. When one of the above communication devices communicate with the central management apparatus 102, the central management apparatus 102 accurately determines whether or not the communication device is registered under the agreement by checking the device number in the certificate received from the communication device to be used for mutual confirmation during the SSL communication.

(2) The CPU 151 of the communication terminal 150 adds a certificate transmission request the identification information or the device numbers of the communication devices that have been produced that day and transmits the certificate transmission request to the certificate management device 607. The certificate transmission request is used for mutual confirmation during the SSL communication by the produced communication devices. In response to the device-number-added certificate transmission request, the communication terminal 150 receives the certificates each including a device number and stores the certificates in the certificate database 154a. When the input device 156 inputs the device numbers to the communication terminal 150, the communication terminal 150 reads a certificate corresponding to each of the inputted device numbers from the certificate database 154a. The read certificates are transmitted via the factory terminal 160 to the above communications devices whose device numbers have been scanned. The transmitted certificate is then written to the non-volatile memory of the communication device. By the above described process, the substantially identical effect is obtained as in the case of (1). However, since the device numbers are inputted by the input device 156, it is necessary to be cautious with input errors.

(3) In transmitting the certificates to the corresponding communication devices from the factory terminal 160 of (1) or (2), the CPU 161 of the factory terminal 160 performs the mutual confirmation with the communication device based upon the common certificate and codes the certificate to be sent to the communication device. By the coding, the security is improved between the factory terminal 160 and the communication device.

(4) When the CPU 151 of the communication terminal 150 completes the writing of the certificates in the non-volatile memory of the corresponding communication devices, the write complete flag is set to “1” to indicate that the certificate has been written in the certificate database 154a. By the above flag, since the certificate-written communication devices are specified, the production management of the communication devices is improved.

(5) When the CPU 151 of the communication terminal 150 completes the writing of the certificates in the non-volatile memory of the corresponding communication devices, the certificates are deleted from the certificate database 154a. By the deleting, the substantially identical effect is obtained as in the case of (4). Furthermore, since security becomes a concern if the certificates are maintained in the certificate database 154a for a long period of time, by deleting from the certificate database 154a the certificates that have been written to the communication devices, the security is improved.

Furthermore, the CPU 151 of the communication terminal 150 adds a certificate transmission request the identification information or the device numbers of the communication devices that have been produced that day and transmits the certificate transmission request to the certificate management device 607. The certificate transmission request is used for mutual confirmation during the SSL communication by the produced communication devices. In response to the device-number-added certificate transmission request, the communication terminal 150 receives the certificates each including a device number and transmits the certificates to the communication devices via the factory terminal 160. The transmitted certificate is then written to the non-volatile memory of the communication device. By writing directly, the certificate database 154a is eliminated to reduce the costs.

In the above, the preferred embodiments suited for the communication terminal 150 and the factory terminal 160 have been described above for writing the certificates in the non-volatile memory of the image forming devices 100, 110 and the intermediate device 101. The current invention is not limited to the above disclosures and is also applicable for information processing devices for writing the certificates in the non-volatile memory of the communication devices in the water, electricity and gas consumption measuring units, air conditioning units, electrical power supply units, medical devices, automatic vending machines, the network-based consumer electronics as well as computers that are connected to the network. The computer software programs according to the current invention also implements the functions of the digital certificate generation means, a digital certificate transmission means, a write complete information setting means and a digital certificate deletion means by the CPUs 131 and 151 for controlling the communication terminal 150 and the factory terminal 160. The above described effects are obtained by executing the software programs at the computer. At the installation, the above software programs are stored in the memory means such as ROM or HDD in the computer. Alternatively, the software programs are stored in other non-volatile memory media such as CD-ROM, floppy disks, SRAM, EEPROM and memory cards. In order to implement the each process, the software programs are read from the stored memory by the CPU for execution or installed in the computers for later execution by the CPU. The software programs are also downloaded for execution from the peripheral devices that have the memory means storing the software programs or that store the software programs.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of obtaining a digital certificate for communication devices, comprising the steps of:
storing digital certificates each with corresponding identification information in a digital certificate management device;
adding identification information of a communication device to a digital certificate transmission request for obtaining a digital certificate to be used for confirming the communication device during communication;
transmitting the identification-information-added digital certificate transmission request to the digital certificate management device;
receiving a corresponding one of the digital certificates from the digital certificate management device in response to the identification-information-added digital certificate transmission request;
transmitting the correspondingly received digital certificate to the communication device; and
writing the correspondingly received digital certificate to memory in the communication device.

2. A method of obtaining a digital certificate for communication devices, comprising the steps of:
storing digital certificates each with corresponding identification information in a digital certificate management device;
adding identification information of a predetermined number of communication devices for production to a digital certificate transmission request for obtaining digital certificates to be used for confirming the communication devices during communication;
transmitting the identification-information-added digital certificate transmission request to the digital certificate management device;
receiving corresponding ones of the digital certificates from the digital certificate management device in response to the identification-information-added digital certificate transmission request;
temporarily storing the correspondingly received digital certificates in memory of an information processing device;
inputting a portion of the identification information on the predetermined number of the communication devices;
reading the digital certificates corresponding to the inputted identification information from the information processing device;
transmitting each of the correspondingly read digital certificates to a corresponding one of the communication devices according to the inputted identification information; and
writing each of the correspondingly read digital certificates to memory in the corresponding one of the communication devices.

3. The method of obtaining a digital certificate for communication devices according to claim 2 further comprising an additional step of coding each of the correspondingly read digital certificates prior to transmitting to a corresponding one of the communication devices according to the inputted identification information.

4. The method of obtaining a digital certificate for communication devices according to claim 2 further comprising an additional step of setting a completion flag indicative of successfully writing the digital certificate in the communication device upon successfully completing said writing step.

5. The method of obtaining a digital certificate for communication devices according to claim 2 further comprising an additional step of deleting the digital certificate from the information processing device upon successfully completing said writing step.

6. A method of obtaining a digital certificate for communication devices, comprising the steps of:
storing digital certificates each with corresponding identification information in a digital certificate management device;
adding identification information of a predetermined number of communication devices for production to a digital certificate transmission request for obtaining digital certificates to be used for confirming the communication devices during communication;
transmitting the identification-information-added digital certificate transmission request to the digital certificate management device;
receiving corresponding ones of the digital certificates from the digital certificate management device in response to the identification-information-added digital certificate transmission request;
temporarily storing the correspondingly received digital certificates in memory of an information processing device;
scanning a barcode indicative of the identification information on the predetermined number of the communication devices from a predetermined source;
reading the digital certificates corresponding to the scanned identification information from the information processing device;
transmitting each of the correspondingly read digital certificates to a corresponding one of the communication devices according to the scanned identification information; and
writing each of the correspondingly read digital certificates to memory in the corresponding one of the communication devices.

7. The method of obtaining a digital certificate for communication devices according to claim 6 further comprising an additional step of coding each of the correspondingly read digital certificates prior to transmitting to a corresponding one of the communication devices according to the scanned identification information.

8. The method of obtaining a digital certificate for communication devices according to claim 6 further comprising an additional step of setting a completion flag indicative of successfully writing the digital certificate in the communication device upon successfully completing said writing step.

9. The method of obtaining a digital certificate for communication devices according to claim 6 further comprising an additional step of deleting the digital certificate from the information processing device upon successfully completing said writing step.

10. An information processing apparatus for obtaining a digital certificate for communication devices, comprising:
a digital certificate transmission request unit for adding identification information of a communication device to a digital certificate transmission request for obtaining a digital certificate to be used for confirming the communication device during communication and transmitting the identification-information-added digital certificate transmission request to a digital certificate management device; and
a digital certificate processing unit connected to said digital certificate transmission request unit for receiving a corresponding one of the digital certificates from the digital certificate management device in response to the identification-information-added digital certificate transmission request, said processing digital certificate unit
transmitting the correspondingly received digital certificate to the communication device and writing the correspondingly received digital certificate to memory in the communication device.

11. An information processing apparatus for obtaining a digital certificate for communication devices, comprising:
a digital certificate transmission request unit for adding identification information of a predetermined number of communication devices for production to a digital certificate transmission request for obtaining digital certificates to be used for confirming the communication devices during communication, said digital certificate transmission request unit transmitting the identification-information-added digital certificate transmission request to a digital certificate management device;
a digital certificate processing unit connected to said digital certificate transmission request unit for receiving corresponding ones of the digital certificates from the digital certificate management device in response to the identification-information-added digital certificate transmission request, said digital certificate processing unit temporarily storing the correspondingly received digital certificates in memory of an information processing device; and
an inputting unit connected to said digital certificate processing unit for inputting a portion of the identification information on the predetermined number of the communication devices to said digital certificate processing unit, wherein said digital certificate processing unit reading the digital certificates corresponding to the inputted identification information from the information processing device, said digital certificate processing unit transmitting each of the correspondingly read digital certificates to a corresponding one of the communication devices according to the inputted identification information and writing each of the correspondingly read digital certificates to memory in the corresponding one of the communication devices.

12. The information processing apparatus for according to claim 11 further comprising a coding unit connected to said digital certificate processing unit for coding each of the correspondingly read digital certificates prior to transmitting to a corresponding one of the communication devices according to the inputted identification information.

13. The information processing apparatus for according to claim 11 further comprising a flag setting unit connected to said digital certificate processing unit for setting a completion flag indicative of successfully writing the digital certificate in the communication device after said digital certificate processing unit successfully completes writing of the digital certificate in the communication device.

14. The information processing apparatus for according to claim 11 further comprising a deleting unit connected to said digital certificate processing unit for deleting the digital certificate from the information processing device after said digital certificate processing unit successfully completes writing of the digital certificate in the communication device.

15. An information processing apparatus for obtaining a digital certificate for communication devices, comprising:
a digital certificate transmission request unit for adding identification information of a predetermined number of communication devices for production to a digital certificate transmission request for obtaining digital certificates to be used for confirming the communication devices during communication, said digital certificate transmission request unit transmitting the identification-information-added digital certificate transmission request to a digital certificate management device;
a digital certificate processing unit connected to said digital certificate transmission request unit for receiving corresponding ones of the digital certificates from the digital certificate management device in response to the identification-information-added digital certificate transmission request, said digital certificate processing unit temporarily storing the correspondingly received digital certificates in memory of an information processing device; and
a scanning unit connected to said digital certificate processing unit for scanning a barcode indicative of the identification information on the predetermined number of the communication devices from a predetermined source, wherein said digital certificate processing unit reading the digital certificates corresponding to the scanned identification information from the information processing device, said digital certificate processing unit transmitting each of the correspondingly read digital certificates to a corresponding one of the communication devices according to the scanned identification information and writing each of the correspondingly read digital certificates to memory in the corresponding one of the communication devices.

16. The information processing apparatus for according to claim 15 further comprising a coding unit connected to said digital certificate processing unit for coding each of the correspondingly read digital certificates prior to transmitting to a corresponding one of the communication devices according to the inputted identification information.

17. The information processing apparatus for according to claim 15 further comprising a flag setting unit connected to said digital certificate processing unit for setting a completion flag indicative of successfully writing the digital certificate in the communication device after said digital certificate processing unit successfully completes writing of the digital certificate in the communication device.

18. The information processing apparatus for according to claim 15 further comprising a deleting unit connected to said digital certificate processing unit for deleting the digital certificate from the information processing device after said digital certificate processing unit successfully completes writing of the digital certificate in the communication device.

19. An information management system over a network, comprising:
a communication device further comprising a memory unit for storing a digital certificate;
an information processing unit connected to said communication device further comprising:
a digital certificate transmission request unit for adding identification information of a predetermined number of said communication devices for production to a digital certificate transmission request for obtaining digital certificates to be used for confirming said communication devices during communication and for transmitting the identification-information-added digital certificate transmission; and
a first digital certificate transmission unit connected to said digital certificate transmission request unit; and
a digital certificate management unit connected to said information processing unit further comprising:
a digital certificate generation unit for receiving the identification-information-added digital certificate transmission and generating a corresponding one of the digital certificates; and
a second digital certificate transmission unit connected to said digital certificate generation unit for transmitting the corresponding one of the digital certificates to said information processing unit,
wherein said digital certificate transmission unit receiving the corresponding one of the digital certificates from said second digital certificate transmission unit in response to the identification-information-added digital certificate transmission request, said first digital certificate transmission unit transmitting the correspondingly received digital certificate to the communication device and writing the correspondingly received digital certificate to said memory in the communication device.

20. The information management system according to claim 19 wherein said digital certificate transmission unit confirms the communication device based upon the digital certificate and further comprises a coding unit connected to said first digital certificate transmission unit for coding each of the correspondingly read digital certificates prior to transmitting to a corresponding one of the communication devices.

21. The information management system according to claim 19 further comprising a flag setting unit connected to said information processing unit for setting a completion flag indicative of successfully writing the digital certificate in the communication device after said first digital certificate transmission unit successfully completes writing of the digital certificate in the communication device.

22. The information management system according to claim 19 further comprising a deleting unit connected to said information processing unit for deleting the digital certificate from said information processing device after said first digital certificate transmission unit successfully completes writing of the digital certificate in the communication device.

23. An information management system over a network, comprising:
a communication device further comprising a memory unit for storing a digital certificate;
an information processing unit connected to said communication device further comprising:
an input unit for inputting identification information for said communication device;
a digital certificate transmission request unit for adding identification information of a predetermined number of said communication devices for production to a digital certificate transmission request for obtaining digital certificates to be used for confirming said communication devices during communication and for transmitting the identification-information-added digital certificate transmission;
a digital certificate storage unit for storing the digital certificates; and
a first digital certificate transmission unit; and
a digital certificate management unit connected to said information processing unit further comprising:
a digital certificate generation unit for receiving the identification-information-added digital certificate transmission and generating a corresponding one of the digital certificates; and
a second digital certificate transmission unit connected to said digital certificate generation unit for transmitting the corresponding one of the digital certificates to said information processing unit,
wherein said digital certificate storage unit receiving the corresponding one of the digital certificates from said second digital certificate transmission unit in response to the identification-information-added digital certificate transmission request, said first digital certificate transmission unit reading the correspondingly received digital certificate from said digital certificate storage unit based upon the inputted identification information and transmitting the correspondingly read digital certificate to the communication device so as to write the correspondingly read digital certificate to said memory in the communication device.

24. The information management system according to claim 23 wherein said digital certificate transmission unit confirms the communication device based upon the digital certificate and further comprises a coding unit connected to said first digital certificate transmission unit for coding each of the correspondingly read digital certificates prior to transmitting to a corresponding one of the communication devices.

25. The information management system according to claim 23 further comprising a flag setting unit connected to said information processing unit for setting a completion flag indicative of successfully writing the digital certificate in the communication device after said first digital certificate transmission unit successfully completes writing of the digital certificate in the communication device.

26. The information management system according to claim 23 further comprising a deleting unit connected to said information processing unit for deleting the digital certificate from said information processing unit after said first digital certificate transmission unit successfully completes writing of the digital certificate in the communication device.

27. An information management system over a network, comprising:
a communication device further comprising a memory unit for storing a digital certificate;
an information processing unit connected to said communication device further comprising:
a scanning unit for scanning a barcode from said communication device as identification information for said communication device;
a digital certificate transmission request unit for adding identification information of a predetermined number of said communication devices for production to a digital certificate transmission request for obtaining digital certificates to be used for confining said communication devices during communication and for transmitting the identification-information-added digital certificate transmission;
a digital certificate storage unit for storing the digital certificates; and
a first digital certificate transmission unit; and
a digital certificate management unit connected to said information processing unit further comprising:
a digital certificate generation unit for receiving the identification-information-added digital certificate transmission and generating a corresponding one of the digital certificates; and
a second digital certificate transmission unit connected to said digital certificate generation unit for transmitting the corresponding one of the digital certificates to said information processing unit,
wherein said digital certificate storage unit receiving the corresponding one of the digital certificates from said second digital certificate transmission unit in response to the identification-information-added digital certificate transmission request, said first digital certificate transmission unit reading the correspondingly received digital certificate from said digital certificate storage unit based upon the scanned identification information and transmitting the correspondingly read digital certificate to the communication device so as to write the correspondingly read digital certificate to said memory in the communication device.

28. The information management system according to claim 27 wherein said digital certificate transmission unit confirms the communication device based upon the digital certificate and further comprises a coding unit connected to said first digital certificate transmission unit for coding each of the correspondingly read digital certificates prior to transmitting to a corresponding one of the communication devices.

29. The information management system according to claim 27 further comprising a flag setting unit connected to said information processing unit for setting a completion flag indicative of successfully writing the digital certificate in the communication device after said first digital certificate transmission unit successfully completes writing of the digital certificate in the communication device.

30. The information management system according to claim 27 further comprising a deleting unit connected to said information processing unit for deleting the digital certificate from said information processing unit after said first digital certificate transmission unit successfully completes writing of the digital certificate in the communication device.

31. A computer program performing certain functions for ultimately writing a digital certificate in a memory unit in communication devices, the functions comprising:
storing digital certificates each with corresponding identification information in a digital certificate management device;
transmitting an identification-information-added digital certificate transmission request to the digital certificate management device after adding identification information of a communication device to the identification-information-added digital certificate transmission request for obtaining a digital certificate to be used for confirming the communication device during communication; and
transmitting a correspondingly received digital certificate to the communication device and writing the correspondingly received digital certificate to memory in the communication device after receiving the corresponding one of the digital certificates from the digital certificate management device in response to the identification-information-added digital certificate transmission request.

32. A computer program performing certain functions for ultimately writing a digital certificate in a memory unit in communication devices, the functions comprising:
storing digital certificates each with corresponding identification information in a digital certificate management device;
transmitting an identification-information-added digital certificate transmission request to the digital certificate management device after adding identification information of a predetermined number of communication devices for production to the identification-information-added digital certificate transmission request for obtaining digital certificates to be used for confirming the communication devices during communication;
temporarily storing correspondingly received digital certificates in memory of an information processing device after receiving the corresponding ones of the digital certificates from the digital certificate management device in response to the identification-information-added digital certificate transmission request; and
transmitting each of corresponding digital certificates to a corresponding one of the communication devices according to inputted identification information and writing each of the corresponding digital certificates to memory in the corresponding one of the communication devices after reading the digital certificates corresponding to a portion of the inputted identification information on the predetermined number of the communication devices.

33. The computer program performing certain functions according to claim 32 further comprising an additional function of coding each of the correspondingly read digital certificates prior to transmitting to a corresponding one of the communication devices according to the inputted identification information.

34. The computer program performing certain functions according to claim 32 further comprising an additional function of setting a completion flag indicative of successfully writing the digital certificate in the communication device upon successfully completing said writing function.

35. The computer program performing certain functions according to claim 32 further comprising an additional function of deleting the digital certificate from the information processing device upon successfully completing said writing function.

36. A computer program performing certain functions for ultimately writing a digital certificate in a memory unit in communication devices, the functions comprising:
storing digital certificates each with corresponding identification information in a digital certificate management device;
transmitting an identification-information-added digital certificate transmission request to the digital certificate management device after adding identification information of a predetermined number of communication devices for production to the identification-information-added digital certificate transmission request for obtaining digital certificates to be used for confirming the communication devices during communication;
temporarily storing correspondingly received digital certificates in memory of an information processing device after receiving the corresponding ones of the digital certificates from the digital certificate management device in response to the identification-information-added digital certificate transmission request; and
transmitting each of corresponding digital certificates to a corresponding one of the communication devices according to scanned a barcode indicative of identification information and writing each of the corresponding digital certificates to memory in the corresponding one of the communication devices after reading the digital certificates corresponding to a portion of the scanned identification information on the predetermined number of the communication devices.

37. The computer program performing certain functions according to claim 36 further comprising an additional function of coding each of the correspondingly read digital certificates prior to transmitting to a corresponding one of the communication devices according to the inputted identification information.

38. The computer program performing certain functions according to claim 36 further comprising an additional function of setting a completion flag indicative of successfully writing the digital certificate in the communication device upon successfully completing said writing function.

39. The computer program performing certain functions according to claim 36 further comprising an additional function of deleting the digital certificate from the information processing device upon successfully completing said writing function.

40. A communication device production system in connection with digital certificate management, comprising:
a production management system for managing production of a predetermined set of communication devices;
a digital certificate database for storing digital certificates;
a communication terminal connected to said production management system, said digital certificate database and the digital certificate management for controlling a flow of obtaining the digital certificates from the digital certificate management and delivering the digital certificates to the communication devices based upon a digital certificate request; and
a factory terminal connected to said communication terminal and the communication devices for delivering the digital certificates to the communication devices as specified by the digital certificate request.

41. The communication device production system according to claim 40 wherein the digital certificate request specifies a set of the communication devices.

42. The communication device production system according to claim 40 wherein the digital certificate request specifies a single one of the communication devices.

43. The communication device production system according to claim 40 wherein said production management system issues the digital certificate request.

44. The communication device production system according to claim 40 further comprising an input device connected to said communication terminal for inputting information for the digital certificate request.

45. The communication device production system according to claim 40 further comprising a scanning device connected to said factory terminal for scanning a barcode on the communication device to input to said communication terminal information for the digital certificate request.

46. The communication device production system according to claim 40 wherein said factory terminal delivers the digital certificates to a predetermined set of the communication devices.

47. A method of producing communication devices with digital certificates, comprising the steps of:
managing production lines for a predetermined set of communication devices;
storing digital certificates in a digital certificate database; and
controlling a flow of obtaining the digital certificates from the digital certificate management and delivering the digital certificates to the communication devices based upon a digital certificate request.

48. The method of producing communication devices according to claim 47 wherein the digital certificate request specifies a set of the communication devices.

49. The method of producing communication devices according to claim 47 wherein the digital certificate request specifies a single one of the communication devices.

50. The method of producing communication devices according to claim 47 wherein the production lines issue the digital certificate request.

51. The method of producing communication devices according to claim 47 further comprising a step of inputting information for the digital certificate request.

52. The method of producing communication devices according to claim 47 further comprising an additional step of scanning a barcode on the communication device to input information for the digital certificate request.
